(19) United States
(12) Patent Application Publication
(10) Pub. No.: US 2026/0304112 A1
(43) Pub. Date: Oct. 1, 2026

(54) METHODS AND APPARATUS FOR END-TO-END WTRU-NF SECURITY POLICY MANAGEMENT WITH PQC PROTECTION

(71) Applicant: InterDigital Patent Holdings, Inc., Wilmington, DE (US)

(72) Inventors: Chonggang Wang, Princeton, NJ (US); Samir Ferdi, Kirkland (CA); Alec Brusilovsky, Downingtown, PA (US); Yi Zhang, San Jose, CA (US); Zhibi Wang, Woodridge, IL (US); Robert Gazda, Spring City, PA (US)

(73) Assignee: InterDigital Patent Holdings, Inc., Wilmington, DE (US)

(21) Appl. No.: 19/092,823

(22) Filed: Mar. 27, 2025

(51) Int. Cl. H04W 12/0431; H04L 9/40; H04W 8/22; H04W 76/10

(52) U.S. Cl. CPC H04W 12/0431; H04L 63/1408; H04W 8/22; H04W 76/10

(57) ABSTRACT

A method may be implemented by a wireless transmit/receive unit (WTRU), including sending, to a network, a protocol data unit (PDU) session establishment request, which may include an indication of a network function (NF) intent and security requirements. NF-specific security policies (NFSSPs) may be received from the network in response to the PDU session establishment request. The NFSSPs may be associated with a target NF instance. The NFSSPs may be determined to be valid NFSSPs based on a signature associated with each of the NFSSPs. Post-quantum cryptography (PQC) algorithms may be determined based on the valid NFSSPs or WTRU context information. End-to-end communication may be performed with the target NF instance based on the valid NFSSPs using the PQC algorithms. A security monitoring report may be sent to the network and may be based on a WTRU security monitoring report policy for each of the valid NFSSPs.

### BACKGROUND

Post-quantum cryptography may refer to cryptographic techniques that are designed to be secure against both classical and quantum computing attacks. Quantum computing may change the dynamics of computing in the coming years. One major concern associated with post-quantum threats is the potential for perfect forward secrecy attacks through a “store-now-decrypt-later” or “harvest-now-decrypt-later” model, in which encrypted data is stored with the intent to decrypt it in the future once quantum computing becomes feasible.

### SUMMARY

A wireless transmit/receive unit (WTRU) may include a processor. The processor may be configured to send, to a network, a protocol data unit (PDU) session establishment request. The PDU session establishment request may include one or more of an indication of a network function (NF) intent and one or more security requirements. The processor may be configured to receive, from the network NF-specific security policies (NFSSPs) in response to the PDU session establishment request. The NFSSPs may be associated with a target NF instance. The processor may be configured to determine that one or more of the NFSSPs are valid NFSSPs based on a signature associated with each of the NFSSPs, determine one or more post-quantum cryptography (PQC) based on one or more of the valid NFSSPs or WTRU context information, and to perform end-to-end communication with the target NF instance based on the valid NFSSPs. The processor may be configured to send the security monitoring report to the network. The security monitoring report may be based on (e.g., generated based on) a WTRU security monitoring report policy (e.g., a WTRU security monitoring report generation and notification policy) for each of the valid NFSSPs.

The processor may be configured to generate the NF intent and the one or more security requirements by determining one or more information elements that define the security requirements or the NF intent. The information elements may indicate one or more of a post-quantum cryptography capability of the WTRU, a description of a target network function, a desired output from the network function, or one or more quality of service (QoS) requirements.

The PDU session establishment request may include one or more of a WTRU context or quality of service (QoS) requirements. The NFSSPs may indicate security policies for the WTRU and the target NF instance. The NF intent may indicate one or more of a description of a network function or a desired output from the network function. The WTRU context may indicate one or more of a location of the WTRU, a time, a connectivity type, or an access network type.

The NFSSPs may include one or more post-quantum cryptography (PQC) algorithms for communication between the WTRU and the target NF instance.

The processor may be configured to monitor NF-instance-specific security events based on one or more security monitoring events at the WTRU contained in the valid NFSSPs.

The processor may be configured to generate a WTRU security context including a post-quantum cryptography capability of the WTRU, and to send a registration request message to the network. The registration request message may include the WTRU security context.

The processor may be configured to receive a registration accept message including one or more of a general security policy (GSP) identifier, a uniform resource identifier (URI), or a uniform resource locator (URL) of one or more GSPs.

The processor may be configured to receive, from the network, the one or more general security policies (GSPs) based on one or more of the GSP identifier, the URI, or the URL, and to store the one or more GSPs received from the network.

The one or more general security policies (GSPs) may include a list of NF types that the WTRU is allowed to communicate with directly and parameters used to establish the PDU session. The parameters may include one or more of a data network name (DNN), a single network slice selection assistance information (S-NSSAI), or an identifier of an evolved session management function (eSMF).

The processor may be configured to verify the one or more general security policies (GSPs), enforce the one or more GSPs, monitor security-related events according to the one or more GSPs, generate one or more security monitoring reports, and send the security monitoring reports to the network.

A method may be implemented by a wireless transmit/receive unit (WTRU), including sending, to a network, a protocol data unit (PDU) session establishment request. The PDU session establishment request may include one or more of an indication of a network function (NF) intent and one or more security requirements. NF-specific security policies (NFSSPs) may be received from the network in response to the PDU session establishment request. The NFSSPs may be associated with a target NF instance. One or more of the NFSSPs may be determined to be valid NFSSPs based on a signature associated with each of the NFSSPs. One or more post-quantum cryptography (PQC) algorithms may be determined based on one or more of the valid NFSSPs or WTRU context information. End-to-end communication may be performed with the target NF instance based on the valid NFSSPs using one or more of the one or more PQC algorithms. A security monitoring report may be sent to the network and may be based on (e.g., generated based on) a WTRU security monitoring report policy (e.g., a WTRU security monitoring report generation and notification policy) for each of the valid NFSSPs.

The method may include generating the NF intent and the one or more security requirements by determining one or more information elements that define the security requirements or the NF intent. The information elements may indicate one or more of a post-quantum cryptography capability of the WTRU, a description of a target network function, a desired output from the network function, or one or more quality of service (QoS) requirements.

The PDU session establishment request may include one or more of a WTRU context or quality of service (QoS) requirements. The NFSSPs may indicate security policies for the WTRU and the target NF instance. The NF intent may indicate one or more of a description of a network function or a desired output from the network function. The WTRU context may indicate one or more of a location of the WTRU, a time, a connectivity type, or an access network type.

The NFSSPs may include one or more post-quantum cryptography (PQC) algorithms for communication between the WTRU and the target NF instance.

The method may include monitoring NF-instance-specific security events based on one or more security monitoring events at the WTRU contained in the NFSSPs.

The method may include generating a WTRU security context including a post-quantum cryptography capability of the WTRU, and sending a registration request message to the network. The registration request message may include the WTRU security context.

The method may include receiving a registration accept message comprising one or more of a general security policy (GSP) identifier, a uniform resource identifier (URI), or a uniform resource locator (URL) of one or more GSPs.

The method may include receiving, from the network, the one or more general security policies (GSPs) based on one or more of the GSP identifier, the URI, or the URL, and storing the one or more GSPs.

The one or more general security policies (GSPs) may include a list of NF types that the WTRU is allowed to communicate with directly and parameters used to establish the PDU session. The parameters may include one or more of a data network name (DNN), a single network slice selection assistance information (S-NSSAI), or an identifier of an evolved session management function (eSMF).

The method may include verifying one or more general security policies (GSPs), enforcing the one or more GSPs, monitoring security-related events according to the one or more GSPs, generating one or more security monitoring reports, and sending the security monitoring reports to the network.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example system for end-to-end WTRU-NF communication according to an embodiment.

FIG. 3 is a diagram illustrating an example hybrid system architecture for end to end (E2E) WTRU-NF communication according to an embodiment.

FIG. 4 is a diagram illustrating an example evolved architecture with RAN support for SBI-based WTRU-NF communication according to an embodiment.

FIG. 5 is a diagram illustrating example overall solutions for GSP and NFSSP creation and management according to an embodiment.

FIG. 6 is a diagram illustrating an example method for creating GSPs after completing primary authentication according to an embodiment.

FIG. 7 is a diagram illustrating an example method for creating GSPs after RES* verification according to an embodiment.

FIG. 8 is a diagram illustrating an example method for creating GSPs in a modified primary authentication flow according to an embodiment.

FIG. 9 is a diagram illustrating an example method for GSP creation and verification after successful registration according to an embodiment.

FIG. 10 is a diagram illustrating an example method for GSP creation and enforcement in a roaming scenario according to an embodiment.

FIG. 11 is a diagram illustrating an example method for NFSSP creation during PDU session establishment using SMF to configure NFSSPs to target NF instance according to an embodiment.

FIG. 12 is a diagram illustrating an example method for NFSSP creation during PDU session establishment with SECMF to configure NFSSPs to target NF instance according to an embodiment.

FIG. 13 is a diagram illustrating an example method for NFSSP creation during PDU session establishment using SECMF-based target NF selection according to an embodiment.

FIG. 14 is a diagram illustrating an example method for NFSSP creation during PDU session establishment with direct SECMF-to-target NF configuration according to an embodiment.

FIG. 15 is a diagram illustrating an example method for NFSSP creation during PDU session establishment where SMF discovers NF instances and SECMF performs selection according to an embodiment.

FIG. 16 is a diagram illustrating an example method for NFSSP creation during PDU session establishment using direct SECMF configuration to a selected NF according to an embodiment.

FIG. 17 is a diagram illustrating an example method for pushing GSPs/NFSSPs to a WTRU via WTRU parameter update according to an embodiment.

FIG. 18 is a diagram illustrating an example method for pushing GSPs/NFSSPs to a WTRU via WTRU configuration update with AUSF protection according to an embodiment.

FIG. 19 is a diagram illustrating an example method for pushing GSPs/NFSSPs to a WTRU via WTRU configuration update according to an embodiment.

### DETAILED DESCRIPTION

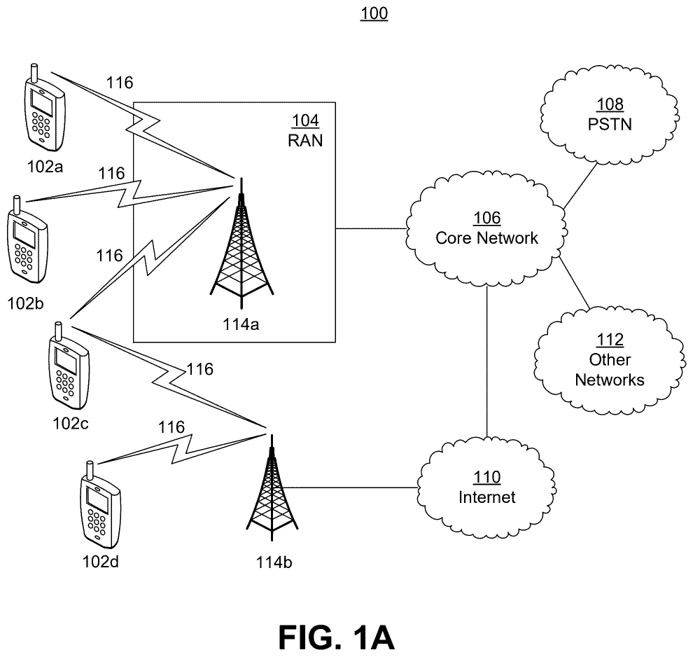

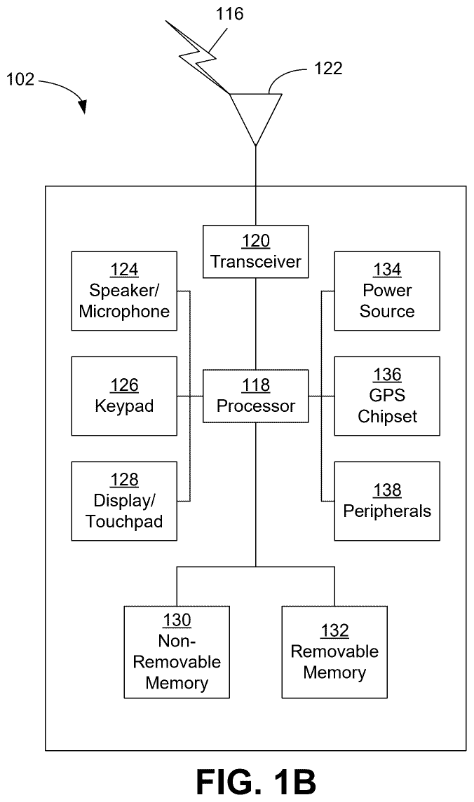

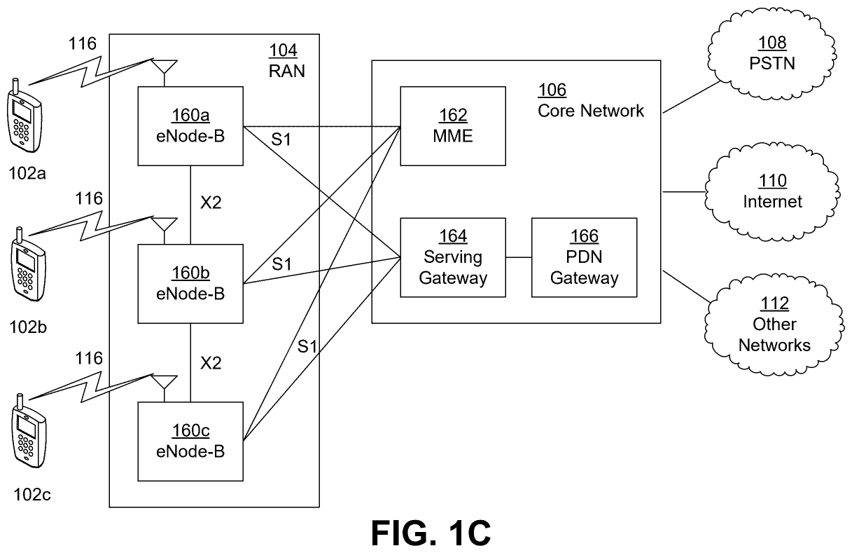

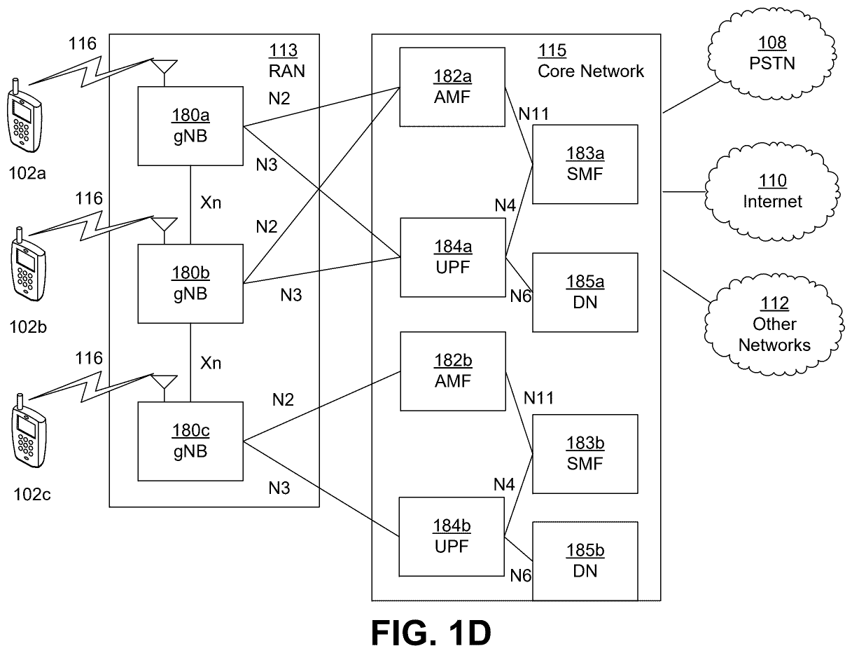

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane (CP) function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Mechanisms are described herein where the system (e.g., 6 generation system (6GS)) may enable security policy management to facilitate the setup of quantum safe, secure end to end communication between a wireless transmit/receive unit (WTRU) and a network function (NF) in the core network (e.g., 6 generation core network (6GC)). A new security management function (SECMF) may be designed for security policy management which may consider both post quantum cryptography (PQC) and classical non PQC cryptograph algorithms.

The WTRU may register itself to 6GC (e.g., an evolved access and mobility management function (eAMF)) with its security context (e.g., PQC capability) via a registration request message or a registration update message. If the WTRU passes primary authentication, SECMF may be notified.

The SECMF may obtain the WTRU security context, WTRU subscription data, and some existing and relevant policies, based on which SECMF may create initial general security policies (e.g., general security policies (GSPs)) for the WTRU. A general security policy may not be for a specific NF instance but may specify a list of NF types or names (e.g., not a specific NF instance) that the WTRU may interact with directly. The general security policy may also specify that the WTRU may be allowed to establish a protocol data unit (PDU) session to interact directly with listed NF types.

SECMF may send the created general security policies to the eAMF. The eAMF may include the created general security policies in a registration accept message and may send it to the WTRU, or alternatively may only contain the identifier of the created general security policies (e.g., a general security policy (GSP) identifier in the registration accept message. The WTRU may receive the general security policies from the eAMF, and the WTRU may also retrieve the general security policies from the eAMF or SECMF after registration is complete.

The WTRU may store the received general security policies and may start to enforce security policies according to what is specified in the general security policies. For example, the WTRU may start to contact NFs that use the way (e.g., directly and/or indirectly) as specified in the general security policies. The WTRU may also begin monitoring security related events, may generate security monitoring reports, and may send them to 6GC (e.g., to SECMF) according to the general security policies.

Mechanisms are described herein where the system (e.g., 6 generation system (6GS)) may enable security policy management to generate NF instance specific security policies during PDU session establishment to facilitate quantum safe, secure end to end communication between a WTRU and an NF in the core network (e.g., 6 generation core network (6GC). A new security management function (SECMF) may be designed for security policy management which may consider both PQC and classical non PQC cryptograph algorithms.

The WTRU may first prepare its NF intent (e.g., the type of target NFs that the WTRU needs to interact with) and may then initiate the establishment of a PDU session (or modification of an existing PDU session) via a session management function (SMF) and/or an evolved SMF (eSMF). SMF and eSMF may be interchangeably used in this invention. The WTRU may send its NF intent and its security requirements (e.g., security level, PQC and/or non PQC algorithms) to an evolved SMF (eSMF) via a PDU session establishment request message (or a PDU session modification request).

Both the eSMF and/or SECMF may discover and select an appropriate target NF instance (or more than one, dependent on NF intent) for the WTRU, considering a combination of information such as the WTRU's NF intent, the WTRU's security requirements, target NF profiles, etc. Then, SECMF may create NF specific security policies (NFSSPs) for the WTRU and the selected target NF instance, considering a combination of information such as the WTRU's NF intent, the WTRU's security requirements, target NF profiles, WTRU subscription data, existing and relevant policies, and network security monitoring results (e.g., provided by WTRUs, the target NF instance, other NFs such as the network data analytics function (NWDAF)). Secondary authentication may be executed with SECMF acting as an authentication, authorization, and accounting (AAA) server.

Then, the eSMF or SECMF may configure the created NF specific security policies to the selected target NF instance. The eSMF may send the created NF specific security policies to the WTRU via a PDU session establishment response message (or a PDU session modification response message).

The WTRU may store the received NF specific security policies locally and may start to enforce security policies according to what is specified in the NF specific security policies. For example, the WTRU may start to interact with the selected target NF instance directly over the established PDU session in compliance with the NF specific security policies. For example, the WTRU may also start to monitor events related to the selected target NF instance, may generate NF specific security monitoring reports, and may send them to 6GC (e.g., to SECMF) according to what the NF specific security policies describe. The selected target NF instance may also start to monitor events related to the WTRU and may generate WTRU specific security monitoring reports and may send them to 6GC (e.g., to SECMF) according to what the NF specific security policies describe.

Examples may include the creation of general security policies (GSPs) during a wireless transmit/receive unit (WTRU) registration procedure in order to enable quantum-safe end-to-end communication between the WTRU and one or more network functions (NFs). A WTRU may register to a network with a WTRU security context and may receive general security policies from the network. The general security policies may describe initial policies for facilitating end-to-end WTRU-NF communication.

A WTRU may perform one or more of a plurality of functions. For example, a WTRU may prepare a WTRU security context. The WTRU security context may include WTRU post-quantum cryptography (PQC) capability and other information elements. The WTRU may then send a registration request message (or a registration update message) to the network. The registration request message may be composed of the WTRU security context and other information elements. The WTRU may participate in a primary authentication procedure with the network. The WTRU may receive a registration accept message from the network, and this message may contain general security policy identifiers and/or, for example, a uniform resource identifier (URI) or uniform resource locator (URL) for the general security policies.

The WTRU may use the general security policy identifiers or general security policy URIs/URLs to retrieve general security policies from the network. Once retrieved, the WTRU may receive general security policies from the network. A general security policy may indicate a list of NF types with which the WTRU may directly communicate. A general security policy may also indicate parameters the WTRU may need to use, such as a data network name (DNN), a single network slice selection assistance information (S-NSSAI), and/or an identifier of an enhanced session management function (eSMF), to establish a protocol data unit (PDU) session, which the WTRU may then use to interact directly with a selected target NF instance.

The WTRU may verify the general security policies and may store valid general security policies locally. The WTRU may enforce the general security policies. The WTRU may monitor one or more security-related events. The WTRU may generate security monitoring reports and may transmit those reports to the network.

Examples may include creation of NF-specific security policies during a PDU session establishment procedure to enable quantum-safe end-to-end communication between a WTRU and a target NF instance. A WTRU may send an NF intent to the network, where the NF intent may include an NF description or a desired output. The network may use this NF intent to identify a matching NF instance and to establish or modify a PDU session with the selected target NF instance. The PDU session establishment response sent by the network to the WTRU may include one or more NF-specific security policies. These NF-specific security policies may describe policies specific to communication between the WTRU and the selected NF instance.

A WTRU and the network, such as an enhanced session management function, may authenticate each other and may derive and/or exchange keys using post-quantum cryptography algorithms. The WTRU may prepare security requirements and the NF intent. The WTRU may then send information elements to the network, such as the WTRU's security requirements, NF intent, WTRU context, and quality of service (QoS) requirements, for example via a PDU session establishment request or a PDU session modification request. The WTRU may participate in a secondary authentication procedure with the network.

Following the PDU session request, the WTRU may receive NF-specific security policies in the PDU session establishment response. The NF-specific security policies may contain specific security requirements and configurations (for example, designated post-quantum cryptographic algorithms) for communication between the WTRU and the selected NF instance. The WTRU may verify the signature of the NF-specific security policies and may store valid NF-specific security policies locally.

The WTRU may then communicate with the selected NF instance over the established PDU session while complying with the stored NF-specific security policies. The WTRU may monitor NF-instance-specific security events based on a list of monitoring events that may be included in the NF-specific security policies. The WTRU may generate security monitoring reports based on a policy for report generation and notification included in the NF-specific security policies. The WTRU may send the security monitoring reports to the network.

Quantum computers may threaten cryptographic algorithms that rely on certain types of computational complexity, especially due to the applicability of Shor's algorithm and Grover's search algorithm. Shor's algorithm may allow efficient solving of large integer factorization and discrete logarithms, thereby rendering asymmetric cryptographic methods like Rivest-Shamir-Adleman (RSA) and elliptic curve cryptography (ECC) highly vulnerable. Grover's search algorithm may accelerate the process of brute-force search, which could affect symmetric cryptography; however, such attacks are currently considered infeasible using mid-term quantum computers.

Asymmetric cryptographic techniques, which rely heavily on computational difficulty for their security (such as RSA), may be more susceptible to quantum attacks than symmetric methods. According to the Global Risk Institute, there is a high likelihood that within 25 to 30 years, quantum computers will be able to break RSA encryption using a 2048-bit key in as little as 24 hours.

Quantum-safe cryptography may be designed to maintain the confidentiality and integrity of data exchanges even in the presence of advanced quantum computing capabilities. These algorithms may use mathematical constructs believed to be secure against both classical and quantum attacks. In 2017, the National Institute of Standards and Technology (NIST) began a process to standardize post-quantum cryptography. As part of this process, NIST selected five candidate algorithms for standardization, two for public-key encryption and three for digital signatures.

The selected public-key encryption algorithms include ML-KEM (also known as CRYSTALS-Kyber), which is a lattice-based key encapsulation mechanism standardized under FIPS 203 in 2022, and HQC, a code-based key encapsulation mechanism offering strong robustness and approved in 2025. For digital signatures, the algorithms include ML-Digital Signature Algorithm (DSA) (also known as CRYSTALS-Dilithium), a lattice-based signature algorithm approved under FIPS 204 in 2022; SLH-DSA (also known as SPHINCS+), a stateless hash-based signature scheme approved under FIPS 205 in 2022; and FN-DSA (also known as FALCON), which is a lattice-based digital signature algorithm expected to be approved under FIPS 206 and noted for its small public key size and compact signature output.

These post-quantum cryptographic (PQC) algorithms are designed to withstand the computational capabilities of future quantum computers. Table 1 may present a comparison between the security levels of traditional cryptographic techniques and the newly standardized post-quantum algorithms. Generally, the higher the level of security results in comparatively longer key sizes and/or longer ciphertext and/or signature lengths.

TABLE 1

| Security Level | AES/SHA(2/3) Hardness | PQC Algorithms |
|---|---|---|
| 1 | AES-128 | ML-KEM-512, FN-DSA-512, SLH-DSA-SHA2/SHAKE-128f/s |
| 2 | SHA-256/ SHA3-256 | ML-DSA-44 |
| 3 | AES-192 | ML-KEM-768, ML-DSA-65, SLH-DSA-SHA2/SHAKE-192f/s |
| 4 | SHA-384/SHA3-384 | No algorithm tested at this level |
| 5 | AES-256 | ML-KEM-1024, ML-DSA-87, FN-DSA-1024, SLH-DSA- |
| | | SHA2/SHAKE-256f/s |

A system architecture (e.g., 5G system architecture) may include a wireless transmit/receive unit (WTRU), a radio access network (RAN), and a core network. One of the design principles for 5G system architecture may be service-centric operation, also referred to as service-based architecture (SBA). A 5G core network may include a variety of network functions that may operate together to fulfill and provide needed services to the RAN, the WTRU, and an application server and/or service provider. A network function may access another network function in request/response mode and/or subscription/notification mode via a service-based interface (SBI). Before two network functions may interact with each other, they may first register with a network repository function (NRF) so that each may be discovered from the NRF.

Among these network functions, an access and mobility management function (AMF) may be dedicated to managing the WTRU's access to a 5G system and its mobility. A session management function (SMF) may be responsible for establishing sessions between a WTRU and a 5G core network. An authentication server function (AUSF) may take charge of WTRU authentication. A policy control function (PCF) may provide policy rules for other control plane network functions and WTRUs. The PCF may assign an identifier for each created policy rule, and the identifier may be used by other control plane network functions and WTRUs to refer to the corresponding policy rule.

A user plane function (UPF) may be the only function for the user plane and may facilitate monitoring, managing, controlling, and redirecting user plane traffic flows (e.g., between a WTRU and an application server). A network exposure function (NEF) may enable access to 5G control plane functions to entities (e.g., network applications and/or application servers) that may be outside of a 5G system and may not be in the same trusted domain. A 5G core network may also provide data storage and analytics services through functions (e.g., unified data management (UDM), unified data repository (UDR), unstructured data storage function (UDSF), and/or network data analytics function (NWDAF).

Another critical feature of a 5G system may be network slicing, which may be facilitated by a network slice selection function (NSSF). Although these network functions may be defined as separate logical entities, a particular scenario may require multiple network functions. For example, WTRU mobility may require not only an AMF, but also an AUSF and an SMF. For a type of network function, multiple instances may be instantiated, and an NRF may maintain the information of each instantiated network function instance.

With the emergence of edge computing, some network functions in a 5G core network (e.g., UPF and/or NEF) may be deployed and may reside in an edge network that may be much nearer to and may be potentially co-located with the RAN.

Network (e.g., 5G) security functions may cover four different security domains within a 5G system. These domains may include security for network access between a WTRU and RAN and/or 5G core network (5GC), network domain security between a RAN and a 5GC, user domain security between mobile equipment (ME) and a universal subscriber identity module (USIM), and SBA domain security in a 5GC.

Network (e.g., 5G) access security may be realized mainly through network access authentication, message encryption, and message integrity protection. Network access authentication may include primary authentication and key agreement and secondary authentication.

The primary authentication and key agreement may be designed to enable mutual authentication between a WTRU and a network, and to establish agreed keying material (e.g., an anchor key K_Security Anchor Function (SEAF) at both the network side and the WTRU side (e.g., using an authentication and key agreement (AKA) protocol). The basis behind 5G primary authentication and key agreement may be that the same long-term key K unique to a WTRU may be securely maintained at a USIM and a network. Based on the long-term key, the anchor key K_SEAF and other key materials (e.g., keys for encryption and integrity protection for non-access stratum (NAS) and access stratum (AS) signaling) may be independently and identically derived at the WTRU and at the network, without being exchanged over the air. Mutual authentication may be established when the WTRU and the network may approve to each other that the same long-term key K is known.

The secondary authentication may be designed as an option to provide security between a WTRU and an external data network (DN) as a part of session management. The secondary authentication may rely on an SMF to initiate and coordinate an authentication procedure between a WTRU and a DN (e.g., a DN authentication, authorization, and accounting (AAA) server).

Additionally, 3GPP Technical Report (TR) 33.894 may study some zero-trust architecture (ZTA) principles, including applicability to a 5G system. For example, TR 33.894 may describe a key issue related to the need for continuous security monitoring of network functions, which in the future may be deployed in different environments and scenarios with potential errors and/or malicious attacks.

Impact of quantum attacks to 3GPP systems may be a concern for next generation networks (also referred to as 6GS). In a current 5G era, both symmetric and asymmetric cryptography may be used widely in a 5G system. For example, symmetric cryptography may be used for an AKA protocol and for protection of NAS and AS and user plane on an air interface using 128-bit symmetric key algorithms. Currently, 3GPP SA3 may be enhancing cryptographic strength, particularly focusing on symmetric 256-bit algorithms to bolster security to National Institute of Standards and Technology (NIST) security level 5.

Meanwhile, public key cryptography may also be used in various security domains, including network domain security and SBA domain security (e.g., subscriber permanent identifier (SUPI) protection, transport layer security (TLS)-based Service-Based Interface (SBI), OAuth, TLS-based N2 and N4 interfaces, internet protocol security (IPSec)-based N3 interface, and/or other interfaces). In a 6G era, 3GPP SA3 may be planned to start the work of introducing post-quantum cryptographic (PQC) algorithms in 3GPP protocol specifications.

In a recent white paper, ATIS may have made two recommendations for migrating 3GPP systems (e.g., 5GS) to be a future quantum-safe system (e.g., 6GS) with PQC protection across devices/WTRU, RAN, core network, and interconnect network. A first recommendation (Priority 1) may include addressing harvest-now-decrypt-later (HNDL) attach vulnerabilities, focusing on enhancing encryption methods. A second recommendation may include expanding quantum-safe cryptography to critical communication paths, focusing on protecting signature and authentication mechanisms across 5G domains.

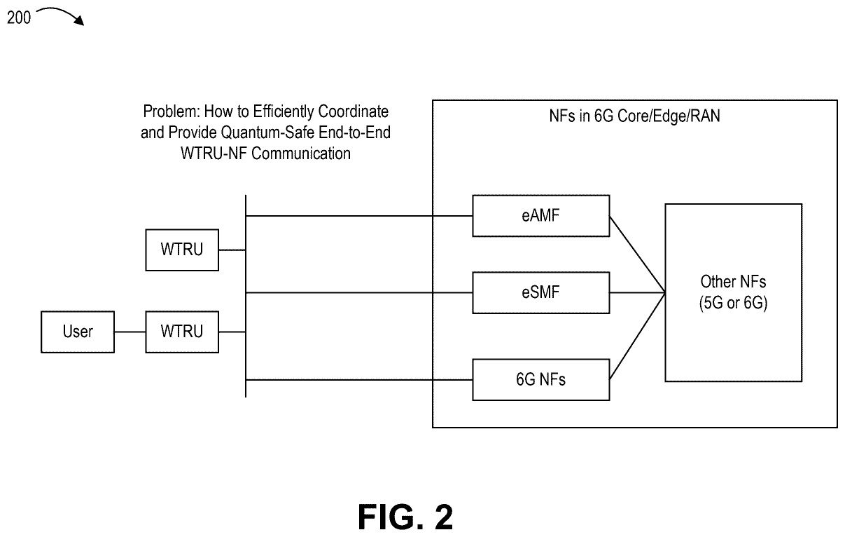

Referring now to FIG. 2, an example system 200 for end-to-end WTRU-NF communication (e.g., in 6GS) is illustratively depicted. A problem statement may relate to expectations that a 6GS may support end-to-end communication between a WTRU and one or more 6G network functions (NFs) (e.g., 6G NFs), referred to as end-to-end WTRU-NF interaction or end-to-end WTRU-NF communication.

For the example shown in FIG. 2, end-to-end WTRU-NF interaction may be supported via a new service-based interface (SBI) referred to as NUP between a WTRU and one or more NFs. The one or more 6G NFs may include evolved 5G NFs and/or new 6G NFs. A UPF may be integrated with a 6G NF under end-to-end WTRU-NF communication. There may be at least one WTRU and one NF involved in each end-to-end WTRU-NF interaction.

First, a 6GS may continue to have a variety of NFs. A 6G system may not allow every NF to be exposed to a WTRU via end-to-end WTRU-NF interaction. For example, certain NFs (e.g., an AUSF) may be protected from being contacted directly by a WTRU. Even if an NF may allow direct end-to-end WTRU-NF interaction, such interaction may be performed via a control plane, a user plane, and/or a new data plane in a 6GS. Different planes may use different communication and security protocols, which may lead to different communication efficiencies and security characteristics and/or performance. A 6GS may need a mechanism to enable a WTRU to be aware of such varieties and to be able to properly prepare for and initiate end-to-end WTRU-NF communications. Thus, end-to-end WTRU-NF communication may need to be effectively established and coordinated.

Second, end-to-end WTRU-NF communication may need to be quantum-safe, in order to prevent potential attacks (e.g., HNDL attacks) from malicious users who may have access to quantum computers. PQC algorithms (e.g., the five PQC algorithms selected by NIST) may be designed for such purposes. These PQC algorithms (with sometimes different parameter sets) may have different complexities (e.g., in terms of computation and communication overhead) and may achieve different security levels and/or categories as illustrated in Table 1. Accordingly, PQC algorithms may need to be carefully selected based on policies for each type and/or instance of end-to-end WTRU-NF communication.

Certain policies and rules may be created to designate appropriate PQC algorithm(s) for end-to-end WTRU-NF interactions. Considering diverse WTRUs and NFs that may emerge in a 6GS, flexible and dynamic security policies between WTRUs and NFs may need to be created and enforced.

For example, some NFs (e.g., an AUSF) may not be allowed to support end-to-end WTRU-NF interaction, while other NFs (e.g., an NWDAF) may support and/or may be expected to support such interaction. To address this, initial general security policies (GSP) may be needed to describe overall policies for end-to-end WTRU-NF interactions. Such general security policies may not be specific to an NF instance and/or even a NF type.

For a particular WTRU-NF interaction between a WTRU and a target NF instance, a security context of the involved WTRU and/or the target NF instance may be subject to change, which may require updated and/or new security policies. Accordingly, one or more NF-specific security policies (NFSSPs) may be created and enforced for the involved WTRU and/or the target NF instance.

Key issues that may need to be addressed may include how to efficiently generate general security policies and enforce them in the WTRU and 6G network, considering both non-roaming and roaming scenarios (e.g., key issue #1). General security policies may contain PQC-related policies and may direct a WTRU through initiation of end-to-end WTRU-NF communication with potential target NFs, and may not be limited to a specific NF type. A 6G network may generate general security policies for a particular WTRU and/or class of WTRUs based on WTRU capabilities (e.g., whether a particular WTRU or class of WTRUs may initiate interaction with 6G NFs).

Another key issue (e.g., key issue #2) may relate to scenarios where a WTRU may start interacting with a specific type of 6G NF. One or more NF-specific security policies may be generated and enforced for such a specific end-to-end WTRU-NF interaction or interaction type between a WTRU and a target NF instance. NF-specific security policies may include PQC policies. The issue may concern how to effectively create proper NF-specific security policies and configure them to the involved WTRU and/or target NF instance(s).

The following figures may illustrate the architecture of the system to coordinate, facilitate, and support quantum-safe secure end-to-end (E2E) WTRU-NF communication based on security policy management.

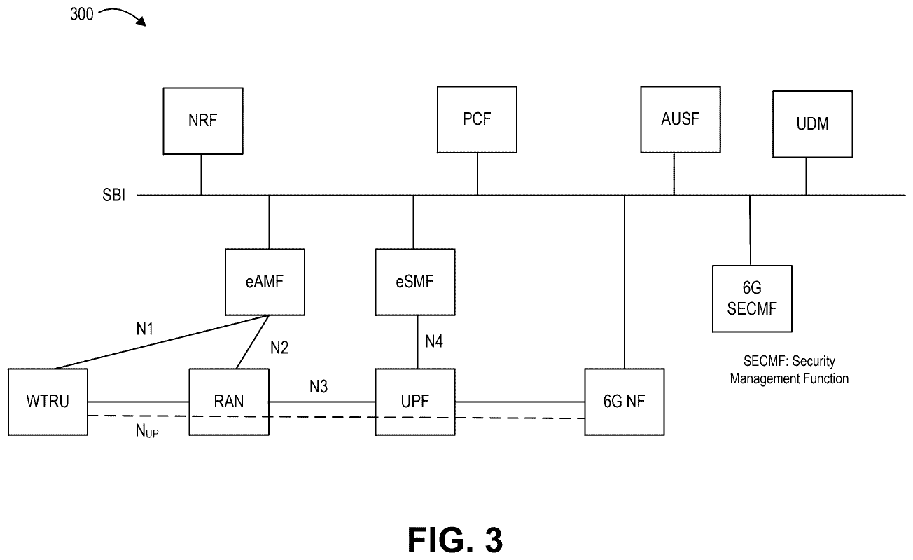

Referring now to FIG. 3, an example hybrid system architecture for E2E WTRU-NF communication is illustratively depicted. A WTRU may use a conventional N1 interface for control-plane-terminated communication with legacy and/or evolved 5GS functions (e.g., AMF, SMF, and/or PCF). The WTRU may use user-plane-based communications via UPF to communicate with applicable new 6G NFs (e.g., data collection, sensing, and/or positioning). The UPF may be integrated with and be a part of 6G NFs and/or RAN.

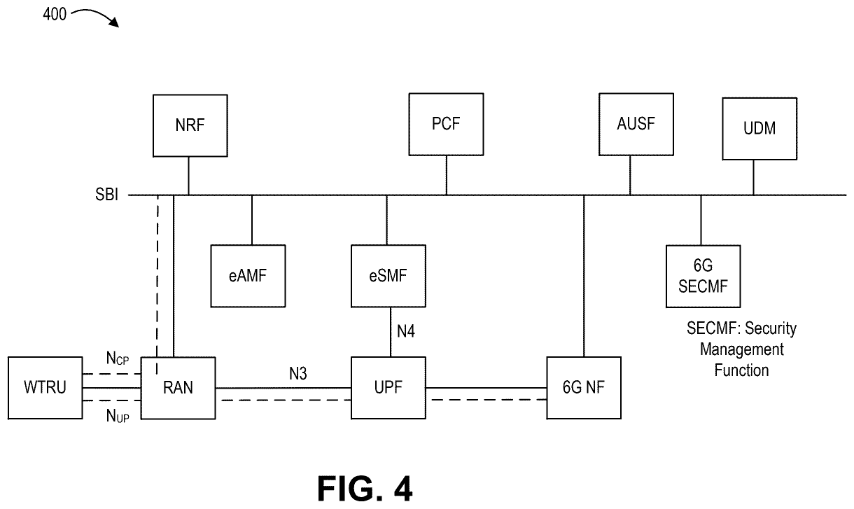

Referring now to FIG. 4, an example evolved system architecture for E2E WTRU-NF communication is illustratively depicted. The difference from the hybrid architecture may be that the WTRU uses RAN as a service-based interface (SBI) gateway for control-plane-terminated communications. The UPF may also be integrated with and be a part of 6G NFs and/or RAN.

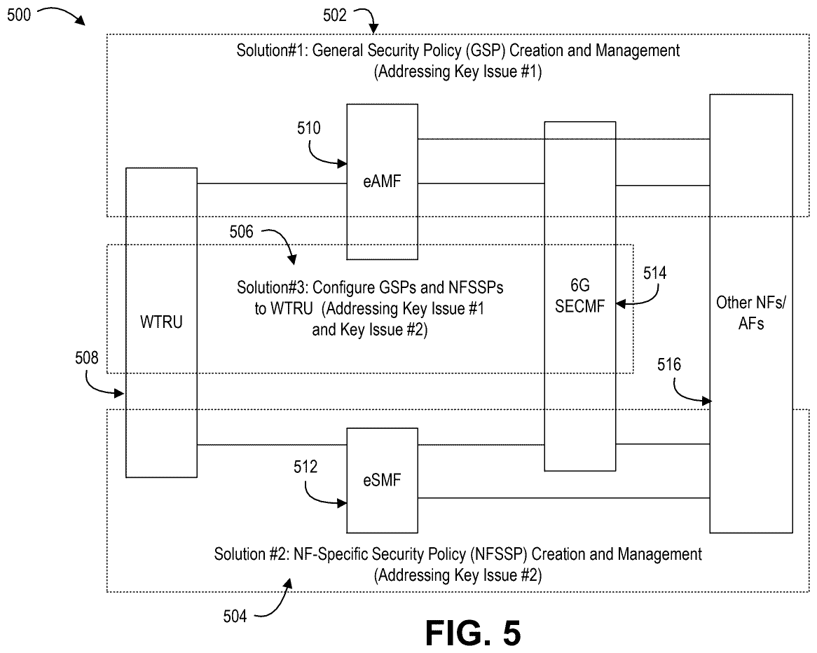

Referring now to FIG. 5, an example architecture 500 for solutions involving a security management function (SECMF) is illustratively depicted. At 502, solution #1 may address key issue #1 by enabling SECMF to create general security policies and configure them to the WTRU with the aid of eAMF during registration. It is noted that eAMF and AMF may be interchangeably used in this invention. The general security policies may be used to coordinate and facilitate the WTRU to choose proper communication modes and communication planes with target NFs.

At 504, solution #2 may address key issue #2 by enabling SECMF to create NF-specific security policies and configure them to the WTRU during PDU session management assisted by eSMF. The NF-specific security policies may be used to guide the WTRU to establish quantum-safe end-to-end WTRU-NF communication with target NFs.

At 506, solution #3 may address both key issue #1 and key issue #2 by allowing SECMF to push and configure general security policies and NF-specific security policies to the WTRU, for example, leveraging WTRU configuration update and WTRU parameter update procedures.

At 508, the WTRU may request or receive configuration of general security policies and/or NF-specific security policies. At 510, the eAMF may assist with delivering the general security policies to the WTRU during registration. At 512, the eSMF may assist with delivery of the NF-specific security policies to the WTRU during PDU session establishment or modification. At 514, the SECMF may interact with other NFs and/or Application Functions (AFs) to obtain relevant information. At 516, the other NFs and/or AFs may also retrieve or be configured with general security policies and/or NF-specific security policies from the SECMF.

The SECMF included in the architecture and overall solution figures may have, but is not limited to, the following functionality. The SECMF may support the creation of general security policies as requested by the WTRU, NFs (e.g., eAMF and/or AUSF), and/or AFs. The SECMF may create general security policies for the WTRU based on information including, but not limited to, WTRU subscription data, existing and applicable Policy and Charging Control (PCC) rules, and WTRU security context. The SECMF may support pushing general security policies to the WTRU, for example using WTRU configuration update mechanisms. The SECMF may support storing general security policies to UDR and/or other NFs. The SECMF may support that the WTRU, NFs, and/or AFs can retrieve general security policies from the SECMF and/or other NFs that maintain NF-specific security policies. In visited networks, the SECMF, when creating general security policies for the visited network, may support consideration of general security policies generated by SECMF in a home network.

The SECMF may support discovery and selection of a target NF instance for an E2E WTRU-NF communication. The SECMF may support creating NF-specific security policies as requested by the WTRU, NFS (e.g., SMF), and/or AFs. The SECMF may create NF-specific security policies for the WTRU, and an NF involved in E2E WTRU-NF communications based on information such as WTRU subscription data, existing and applicable PCC rules, WTRU security context, NF instance security context, and network security monitoring results (e.g., provided by WTRUs, the target NF instance, and/or other NFs such as NWDAF). The SECMF may support storing NF-specific security policies to UDR/UDM and/or other NFs. The SECMF may support that the WTRU, NFs, and/or AFs can retrieve NF-specific security policies from the SECMF and/or other NFs that maintain NF-specific security policies. The SECMF may act as an AAA server and participate in secondary authentication as a part of establishing a PDU session for end-to-end WTRU-NF communication. The SECMF may also be co-located with other existing NFs (e.g., PCF and/or AUSF).

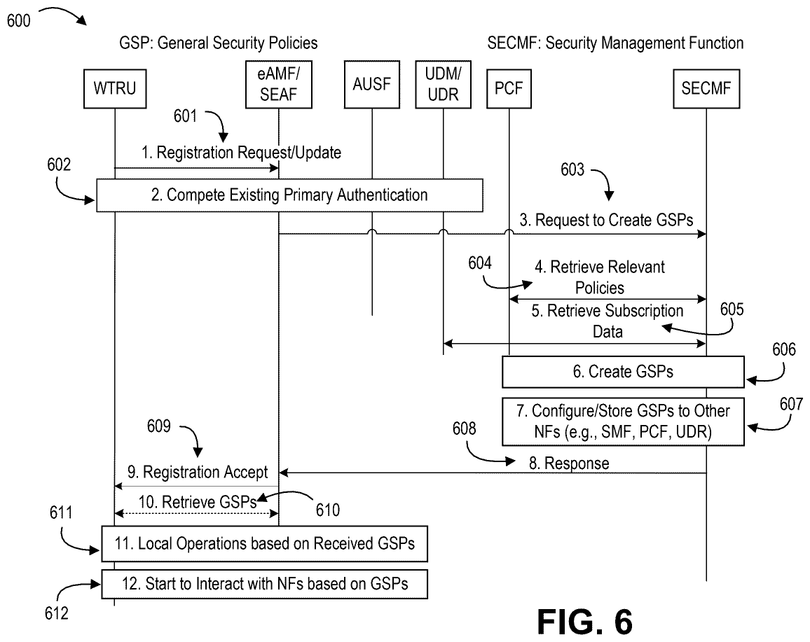

Referring now to FIG. 6, an example method 600 for general security policy (GSP) creation after completing primary authentication is illustratively depicted. After the primary authentication is successful, the eAMF/SEAF (or AUSF) may request the SECMF to create a general security policy for the registering WTRU. The SECMF may retrieve WTRU subscription data from the UDM and/or other existing policies from the PCF. The SECMF may create general security policies based on information including and/or not limited to WTRU subscription data, existing policies, and WTRU security context. After general security policies are created, the SECMF may send them to the eAMF/SEAF. The created general security policies may be contained in a registration accept message and eventually sent from the eAMF/SEAF to the WTRU.

This method may provide a plurality of benefits. For example, it may not introduce an extra message between the WTRU and the eAMF/SEAF since the created general security policies may be contained in the registration accept message. Additionally, and/or alternatively, the existing primary authentication may be reused as is. Thus, the entire existing primary authentication process and design principles behind it may remain unchanged, and the speed of completing the primary authentication may be unaffected.

At 601, the WTRU may send a registration request message and/or a registration update message to the eAMF. In addition to including information elements (IEs) defined for existing registration request or existing registration update messages, the message may include one or more IEs that provide additional context. For example, the message may include a WTRU security context (UESC), which may represent the up-to-date context information about the WTRU from a security perspective. The UESC may be optional. For instance, the UESC may have been previously collected and stored in the network (e.g., at the UDR, UDSF, and/or UDM). If the UESC is not included in the registration request or registration update message, the SECMF may retrieve the UESC from corresponding NFs that maintain the UESC. The UESC may include one or more of a plurality of IEs. For example, the UESC may include a location of the WTRU. The UESC may include a trajectory of the WTRU within a defined time window (e.g., [Start Time, End Time]). The UESC may include an access network type (e.g., 5G, 5GA, 6G, 6GA, satellite, private network, relayed by a relaying UESC, Wi-Fi, other non-cellular access network, etc.) that the WTRU uses. The UESC may include software info such as an operating system version of the WTRU. The UESC may include a post-quantum cryptography (PQC) capability of the WTRU (e.g., supported PQC algorithms and/or quantum-safe capability such as Quantum Key Distribution (QKD)). The UESC may include a conventional cryptography capability of the WTRU (e.g., supported traditional cryptographic algorithms). The UESC may include a user identifier (ID), which may be the identifier of a human user using the WTRU and/or the identifier of an application on the WTRU which will interact with NFs using E2E WTRU-NF communication. The UESC may include a previous GSP ID, which may be an identifier of one or more previously received general security policies that the WTRU received in a prior registration accept message and which may still be valid or not expired.

At 602, the eAMF/SEAF and other NFs such as the AUSF and the UDM may complete the primary authentication. If the primary authentication is unsuccessful, then steps 603 through 608 may be skipped.

At 603, the eAMF/SEAF may select the SECMF which is responsible for creating general security policies for the WTRU and/or for the area or location where the WTRU is from. The eAMF/SEAF may send a “request to create GSPs” message to the selected SECMF. The “request to create GSPs” message may contain one or more IEs. For example, the message may include the WTRU security context, which may be a combination of the UESC and any additional context information that the eAMF/SEAF has maintained for the WTRU. The message may include a WTRUID, which may be an identifier of the WTRU (e.g., SUPI, SUCI, and/or GUTI). The message may include an eAMF/SEAF ID, which may be an identifier of the eAMF and/or the SEAF. The message may include a credential of the eAMF and/or the SEAF. Additionally, and/or alternatively, the “request to create GSPs” message may be sent from the AUSF to the SECMF. In this case, the eAMF/SEAF may need to pass the UESC as received from the WTRU at 601 to the AUSF at 602. Then, the response at 608 may be sent to the AUSF, which may forward the response to the eAMF/SEAF.

At 604, the SECMF may receive the “request to create GSPs” message from 603. The SECMF may first authenticate the eAMF and/or the SEAF based on their credentials. If authentication passes, the SECMF may retrieve any existing policies from the PCF and/or other NFs such as the UDR that could apply to the WTRU. The existing policies may include previously created general security policies. Additionally, and/or alternatively, one example of the existing policies may include a rule that indicates “WTRU-X should use PQC algorithm-Y for E2E WTRU-NF communication [under condition-Z].” Another example of the existing policies may include a rule that indicates “E2E WTRU-NF communication with NF Type-Z should be protected using PQC algorithm-XY.”

At 605, the SECMF may retrieve WTRU subscription data from the UDM and WTRU security context from other NFs such as the UDR. Step 605 may occur before step 604.

At 606, the SECMF may create general security policies based on information such as previously created general security policies for the WTRU that are maintained locally at the SECMF, the WTRU security context received from 603, the WTRU subscription data and WTRU security context retrieved from 605, and existing policies retrieved from 604. A general security policy may include one or more information elements (IEs). For example, the general security policy may include a GSP ID, which may be an identifier for the general security policy. The general security policy may include a GSP Creator, which may be an identifier of the SECMF that created the general security policy. The general security policy may include a priority value, which may be a positive integer, and which may indicate a priority for the general security policy, such that a higher number indicates a higher priority as an example. The general security policy with a higher priority may override general security policies with lower priority.

The general security policy may include a list of target NF types, which may represent one or more NF types and/or names that the general security policy may apply to. For example, the list of target NF types may include a data-related NF, a compute-related NF, an AI-related NF, and/or a security-related NF. The general security policy may include a list of target NF subtypes, which may represent one or more subtypes and/or subnames of NFs that the general security policy may apply to. For example, if the list of target NF types only includes a security-related NF, the list of target NF subtypes may include an AUSF, an SECMF, and/or a key management function. In some cases, the list of target NF subtypes may be merged with the list of target NF types and may not be needed.

The general security policy may include a list of affected WTRUs. The list of affected WTRUs may indicate which WTRUs the general security policy is applicable for and where the general security policy may be enforced. For example, the list of affected WTRUs may include a WTRU that sent the registration request or registration update message at 601. In some cases, the SECMF may create different general security policies for different WTRUs having the same content and/or policies. In such cases, the SECMF may use the same general security policy for multiple WTRUs. The list of affected WTRUs may contain, for each affected WTRU, one or more IEs. For example, an IE may include a WTRU ID (e.g., SUPI, SUCI, and/or GUTI) for the affected WTRU. An IE may include a WTRU location indicating one or more locations and/or areas where the general security policy may be applicable to the WTRU. An IE may include WTRU context, such as time, access network type, and/or other connectivity-level information to define conditions under which the general security policy may be applied to the WTRU. An IE may include a PQC profile, which may be a list of PQC algorithms and/or other quantum-safe schemes (e.g., QKD) that the general security policy may request or enforce for the affected WTRU. An IE may include a list of user IDs identifying users associated with the affected WTRU.

The general security policy may include a communication mode for the WTRU to communicate with NFs indicated by NF type. The communication mode may be direct E2E, which may indicate that the target NFs may allow direct E2E communication with the WTRU. The communication mode may be indirect E2E, which may indicate that the target NFs may allow indirect E2E communication with the WTRU (e.g., via a service communication proxy (SCP) and/or a network function exposure (NEF). The communication mode may be non-E2E, which may indicate that the target NFs may not allow either direct or indirect E2E communication with the WTRU. In such a case, the eAMF may be the only anchor point for forwarding messages between the WTRU and the target NFs.

The general security policy may include an SCP ID, which may be the identifier of the SCP supporting the indirect E2E communication mode. The general security policy may include an NEF ID, which may be the identifier of the NEF supporting the indirect E2E communication mode. The general security policy may include an eAMF ID, which may be the identifier of the eAMF supporting the non-E2E communication mode via the control plane.

The general security policy may include a communication plane, which may indicate the communication plane that the E2E WTRU-NF communication should use. For example, the communication plane may include a control plane, a user plane, a data plane, an intelligence or AI plane, a computation plane, and/or others.

The general security policy may include PDU session parameters, which may indicate parameters used for the WTRU to establish a PDU session. The PDU session parameters may include a data network name (DNN). The DNN may be set to E2E WTRU-NF communication, to an NF name or type (e.g., user profile management function (UPMF)), and/or other values to indicate that the PDU session being established is not for a conventional data network but rather for E2E WTRU-NF interaction. The PDU session parameters may include a single network slice selection assistance information (S-NSSAI).

The general security policy may include SMF contact info. The SMF contact info may provide information for the WTRU to contact the SMF to establish a PDU session for interaction with a target NF and may ensure quantum-safe communication between the WTRU and the SMF. The SMF contact info may include one or more IEs. For example, an IE may include an SMF ID, which may be the identifier of an SMF that supports WTRU-NF communication over a non-control plane (e.g., user plane, data plane, intelligence or AI plane, computation plane). An IE may include an SMF public key. An IE may include an authentication mode. The authentication mode may indicate whether (1) the SMF authenticates the WTRU, (2) the SMF and WTRU mutually authenticate each other, or (3) the WTRU authenticates the SMF (although this third case may rarely occur). An IE may include an authentication scheme, which may be a credential-based authentication, token-based authentication, certificate-based authentication (e.g., mutual TLS), password-based authentication, multi-factor authentication (e.g., additionally use user credentials), multi-factor authentication, and/or others. An IE may include a key exchange scheme. The key exchange scheme may indicate how secret keys may be exchanged between the WTRU and SMF. The WTRU and SMF may exchange multiple secret keys (e.g., one for confidentiality, one for integrity), and thus multiple key exchange schemes may be composed in the IE. Key exchange schemes may include classical schemes (e.g., Diffie-Hellman Key Exchange (DH), RSA, ECDH, Elliptic Curve Diffie-Hellman Ephemeral (ECDHE), Secure Remote Password Protocol (SRP), Kerberos, Authenticated Key Exchange (AKE), Menezes-Qu-Vanstone (MQV)), PQC schemes (e.g., ML-KEM, HQC), quantum schemes (e.g., QKD), or no key exchange scheme (e.g., use key derivation based on KSEAF in 5GS). The key exchange scheme may include a hybrid scheme, where a classical scheme may be used together with a PQC scheme to exchange multiple secret keys.

The SMF contact info may include a confidentiality protection scheme. The confidentiality protection scheme may indicate how to protect the confidentiality of communication between the SMF and the WTRU. The confidentiality protection scheme may include symmetric encryption algorithms (e.g., Advanced Encryption Standard (AES), Data Encryption Standard (DES), Triple DES (3DES), and/or Rivest Cipher 4 (RC4)), asymmetric encryption algorithms (e.g., ECC, lattice-based cryptography), and/or hybrid encryption algorithms (e.g., ECIES). The confidentiality protection scheme may indicate that multiple keys obtained through key exchanges may be used to derive a new secret key using a key derivation function, and the derived key may then be used for confidentiality protection.

The SMF contact info may include an integrity protection scheme. The integrity protection scheme may indicate how to protect the integrity of communication between the SMF and the WTRU. The integrity protection scheme may include message authentication code (MAC) schemes using shared secret keys (e.g., hash-based MAC), digital signature schemes using asymmetric cryptography such as classical schemes (e.g., RSA, DSA, Elliptic Curve Digital Signature Algorithm (ECDSA), Edwards-curve Digital Signature Algorithm (EdDSA), and PQC schemes (e.g., ML-DSA, SLH-DSA, FN-DSA). The integrity protection scheme may include a hybrid scheme that uses a classical digital signature algorithm together with a PQC digital signature algorithm.

The general security policy may include a GSP creation mode. The GSP creation mode may indicate the mode for the WTRU, from the list of affected WTRUs, to request the creation of new general security policies. For example, the GSP creation mode may indicate indirect via registration, which may indicate that the WTRU should use a registration update to request new general security policies. The GSP creation mode may indicate direct via SECMF, which may indicate that the WTRU can directly request the creation of new general security policies from the SECMF.

The general security policy may include the UESC, which may be the same WTRU security context that was received by the eAMF/SEAF at 601. The general security policy may include a UESC-hash, which may be a hash, signature, and/or digest of the UESC that the SECMF used to create the general security policy. The SECMF may generate the UESC-hash using a hash algorithm and/or its private key over the UESC.

The general security policy may include a SECMF ID, which may be the identifier of the SECMF supporting the “direct via SECMF” mode of general security policy creation. The general security policy may include a creation time, which may indicate when the general security policy was created. The general security policy may include an enforcement schedule, which may indicate a schedule for enforcing the general security policy. The enforcement schedule may include one or more time windows, each with a start time and a completion time. The total schedule may occur between the creation time and an expiration time. The general security policy may include an expiration time.

The general security policy may include a list of security monitoring events. The list of security monitoring events may include one or more events for monitoring the dynamic security context at an affected WTRU by the general security policy. For example, a security monitoring event may include a failure of running a specific PQC algorithm. A security monitoring event may include a failure of contacting the SMF. A security monitoring event may include a successful PDU session establishment for a target NF type.

The general security policy may include security monitoring report generation and notification. This IE may indicate that an affected WTRU may generate a security monitoring report, and which entity may be notified of the generated report. For example, the security monitoring report generation and notification may include a report generation mode. The report generation mode may indicate how and when a security monitoring report should be generated. The report generation mode may include one event (or instant), which may indicate that each time an event from the list of security monitoring events occurs at the affected WTRU, the WTRU may generate a security monitoring report. The report generation mode may include N events, which may indicate that only after N events occur, the affected WTRU may generate a security monitoring report including those N events. The report generation mode may include a periodical mode, where the affected WTRU may generate a security monitoring report repeatedly after a defined period.

The general security policy may include a GSP Creator, which may be the identifier of the NF that created the general security policy. The general security policy may include a GSP ID. The general security policy may include a report recipient ID, which may be the identifier of the NF that should receive the security monitoring report (e.g., the GSP Creator). The GSP Creator may analyze the reports locally to adjust or generate new general security policies. Additionally, and/or alternatively, the GSP Creator may include an NWDAF instance to receive the security monitoring report. The NWDAF instance may analyze the reports and generate a summary to be sent to the GSP Creator.

The general security policy may include a SECMF signature. The SECMF signature may be a signature of the SECMF that created the general security policy. The SECMF signature may be generated using a PQC digital signature algorithm and/or a conventional digital signature algorithm. The SECMF signature may be generated based on selected IEs included in the general security policy. For example, the list of affected WTRUs may not be used when generating the SECMF signature.

TABLE 2

| IEs | Values (As an example) |
|---|---|
| GSP ID | “GSP-001” |
| GSP Creator | “SECMF-001” |
| List of Target NF Types | “Data-related NF” |
| List of Affected WTRU ->WTRU ID | “WTRU-001” |
| List of Affected WTRU ->WTRU Location | “City-001” |
| Communication Mode | “Direct E2E”, “Indirect E2E” |
| Communication Plane | “Data Plane”, “User Plane” |
| SMF Contact Info -> SMF ID | “SMF-001” |
| SMF Contact Info -> Public Key | “SMF-Public-Key-XYZ” |
| SMF Contact Info -> Authentication Mode | “Mutual Authentication” |
| SMF Contact Info -> Authentication Scheme | “Mutual TLS” |
| SMF Contact Info -> Key Exchange Scheme | “ML-KEM-768” |
| SMF Contact Info -> Confidentiality Protection | “AES-192” |
| Scheme | |
| SMF Contact Info -> Integrity Protection | “ML-DSA-65” |
| Scheme | |
| Creation Time | “3/16/2025 3:25:41 PM” |
| Enforcement Schedule | “[3/20/2025 3:25:41 PM, |
| | 4/16/2025 3:25:41 PM]” |
| Expiration Time | “4/16/2025 3:25:41 PM” |
| SECMF Signature | “0x2b9c7fe4c95cbd89103be76f2c017c0d343885848f” |

Table 2 illustrates an example general security policy that specifies various information and policies. In this example, the general security policy is created for WTRU-001 at the time Mar. 16, 2025 3:25:41 PM by SECMF-001. SECMF-001 signs the general security policy with the signature “0x2b9c7fe4c95cbd89103be76f2c017c0d343885848f”.

WTRU-001 may communicate with data-related NFs directly or indirectly under certain conditions. For example, communication may be permitted when the location of WTRU-001 is within City-001. Communication may also be permitted during the time window from Mar. 20, 2025 3:25:41 PM to Apr. 16, 2025 3:25:41 PM.

End-to-end WTRU-NF communication may be performed through the data plane or user plane. To initiate such communication with a data-related NF, WTRU-001 may first establish a PDU session via SMF-001. The communication between WTRU-001 and SMF-001 may be protected using post-quantum cryptographic schemes. For example, SMF-001 and WTRU-001 may authenticate each other using “mutual TLS”. Additionally, shared secret keys between SMF-001 and WTRU-001 may be exchanged using a PQC algorithm such as ML-KEM-768. Communication integrity between SMF-001 and WTRU-001 may be protected using ML-DSA-65.

At 607, the SECMF may store and configure the created general security policies to other NFs such as SMF, PCF, UDR, UDM, and/or others. For example, the SECMF may store general security policies to the PCF and/or UDR, where the SMF or other NFs/AFs may later retrieve the general security policies to establish a PDU session between an affected WTRU and a target NF instance. Additionally, and/or alternatively, the SECMF may store general security policies directly to the SMF to support the establishment of a PDU session between an affected WTRU and a target NF instance. The SECMF may also store and maintain the created general security policies locally.

When the SECMF stores general security policies to other NFs (e.g., UDR) or locally, it may compare the newly created general security policies with existing general security policies (in some examples, except for the “list of affected WTRUs” IE). If the new general security policy matches an existing general security policy, the SECMF may reuse the existing policy and update the “list of affected WTRUs” to include the registering WTRU, thereby avoiding storage of duplicate policies.

At 608, the SECMF may send a response to the eAMF/SEAF. The response may contain the created general security policies and the identifier of the registering WTRU that sent the message at 601. The response may also include the identifier(s) of the created general security policies. These identifiers may be used by the WTRU to retrieve the general security policies directly from the SECMF after registration has been successfully completed.

Additionally, and/or alternatively, if the message at 603 was sent by the AUSF to the SECMF, the response may be sent to the AUSF, which may then forward the response to the eAMF/SEAF. Even in such a case, the SECMF may also send the response directly to the eAMF/SEAF, since the original request may contain the identifier of the eAMF/SEAF.

At 609, the eAMF/SEAF receives the response from the SECMF. The eAMF/SEAF may store the general security policies contained in the response locally. The eAMF/SEAF may then send a registration accept message to the WTRU.

If the general security policies in the response include a “list of affected WTRUs” that contains multiple WTRUs (including the registering WTRU), the eAMF/SEAF may remove the identifiers of the other affected WTRUs from each general security policy. The resulting policies, which only apply to the registering WTRU, may then be included in the registration accept message and sent to the WTRU. In such a case, the SECMF should not have included the “list of affected WTRUs” when generating the SECMF signature at 606.

If the general security policies are large in size, including them directly in the registration accept message may make the message inefficient to transmit. In such cases, the registration accept message may only include the identifier(s) of the created general security policies. The WTRU may then use those identifiers to retrieve the general security policies directly from the SECMF. This same approach may apply in both roaming and non-roaming scenarios.

Additionally, and/or alternatively, if the general security policies are too large to be included in the registration accept message, the eAMF may use separate procedures such as a WTRU configuration update or WTRU parameter update to push the general security policies to the WTRU. In that case, the eAMF may simply include the identifier(s) of the general security policies in the registration accept message and allow the WTRU to retrieve the full general security policies at 610.

The registration accept message may also include a “registration status” signed by the eAMF/SEAF. This registration status may indicate whether the registration and/or primary authentication was successful or failed, and the registration expiration time. The registration accept message may additionally include the UESC (that was received by the eAMF from the WTRU at 601) or a UESC-hash. The UESC-hash may be a hash, signature, or digest of the UESC generated using a hash algorithm and/or the private key of the eAMF.

At 610, the WTRU may receive the registration accept message. If the registration accept message contains a UESC-hash (or the UESC), the WTRU may verify it to ensure that the same UESC from 601 was received by the eAMF without change. If the registration accept message only includes the identifiers of the general security policies, the WTRU may send a “GSP retrieval request” to the eAMF, which includes the identifiers. The eAMF may then return a response containing the corresponding general security policies to the WTRU.

At 611, the WTRU may verify the signature of the general security policies received from 609 or 610, for example using the public key of the SECMF, and may store valid general security policies locally. For each general security policy, if it contains a UESC-hash (or the UESC), the WTRU may verify it to ensure that the UESC from 601 was used by the SECMF without change when creating the policy.

The WTRU may begin enforcing the general security policies based on their associated enforcement schedule. If a general security policy includes a “list of security monitoring events,” the WTRU may begin monitoring for those events and may prepare to generate a security monitoring report based on the policy's “security monitoring report generation and notification” settings.

At 612, the WTRU may know how to target NF complying with corresponding general security policies. The WTRU may use IEs contained in the general security policies such as the “list of target NF types,” “communication mode,” “communication plane,” “SCP ID,” “NEF ID,” “SMF ID,” and “PQC profile for affected WTRUs” to determine how to contact the appropriate NF in compliance with the policy.

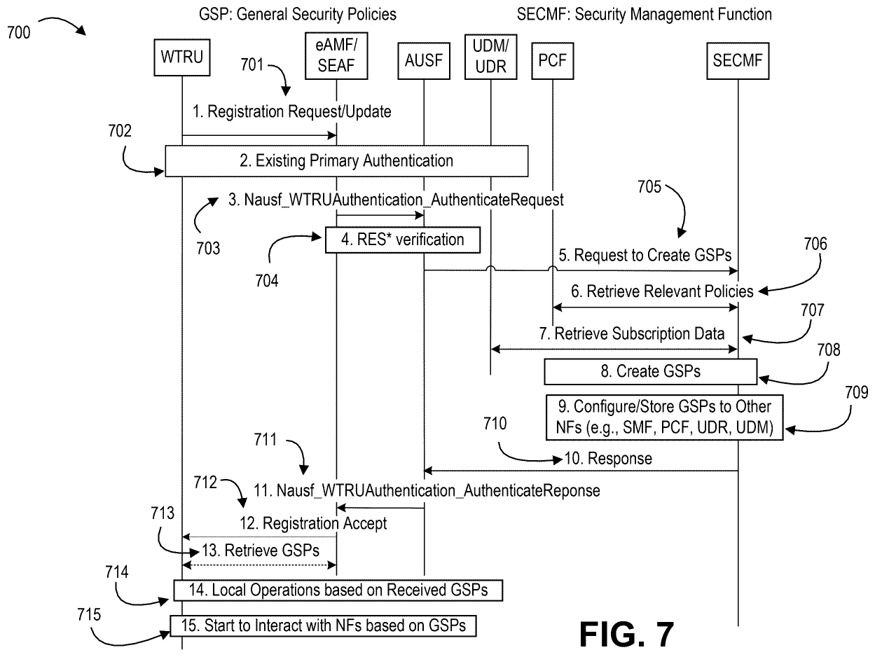

Referring now to FIG. 7, an example method 700 for general security policy (GSP) creation during primary authentication is illustratively depicted.

During authentication, and after the AUSF successfully verifies the RES*, the AUSF may request the SECMF to create a GSP for the registering WTRU. The SECMF may retrieve WTRU subscription data from the UDM, WTRU security context from other NFs (e.g., UDR, NWDAF), and existing policies from the PCF. The SECMF may create one or more GSPs based on information including, but not limited to, the WTRU subscription data, existing policies, and WTRU security context. After the GSPs are created, the SECMF may send them to the AUSF, which may then forward the created GSPs to the eAMF/SEAF via the Nausf_WTRUAuthentication_AuthenticateResponse message. The created GSPs may be contained in a registration accept message and eventually sent from the eAMF/SEAF to the WTRU.

This method 700 may provide various benefits. For instance, it may not introduce extra messages between the WTRU and the eAMF/SEAF, since the created GSPs are included in the registration accept message. Additionally, and/or alternatively, the method 700 may not introduce an extra message between the eAMF/SEAF and the SECMF, since the AUSF is responsible for requesting the creation of the GSPs from the SECMF. However, this may extend the overall completion time of the primary authentication process depending on how quickly the SECMF can create the GSPs.

At 701, the method 700 may perform a similar function as step 601 in FIG. 6.

At 702, the method 700 may conduct existing primary authentication, excluding steps 603, 604, and 611 of FIG. 6.

At 703, the eAMF/SEAF may send a Nausf_WTRUAuthentication_AuthenticateRequest message to the AUSF. This message may include one or more IEs such as the RES* and a WTRU-ID. The WTRU-ID may be an identifier of the registering WTRU, such as a SUPI.

At 704, the AUSF may verify the RES*. If the verification is not successful, steps 705-710 may be skipped, and step 711 may not include any GSPs. If the RES* verification is successful, then the method 700 may proceed with steps 705-710.

At 705, the method 700 may perform a similar function as step 603 in FIG. 6. The message at 705 may include the WTRU-ID received at 703.

At 706, the method 700 may perform a similar function as step 604 in FIG. 6. This step may occur after step 707.

At 707, the method 700 may perform a similar function as step 605 in FIG. 6.

At 708, the method 700 may perform a similar function as step 606 in FIG. 6.

At 709, the method 700 may perform a similar function as step 607 in FIG. 6.

At 710, the method 700 may perform a similar function as step 608 in FIG. 6. The SECMF may send a response to the AUSF, which may include one or more created GSPs and/or identifiers of the created GSPs.

At 711, the AUSF may send a Nausf_WTRUAuthentication_AuthenticateResponse message to the eAMF/SEAF. This message may include IEs such as a result, SUPI, KSEAF, and one or more GSPs created at 708. If the RES* verification at 704 was unsuccessful, then no GSPs may be included in this message. Additionally, and/or alternatively, the message may include only identifiers of the created GSPs.

At 712, the method 700 may perform a similar function as step 609 in FIG. 6.

At 713, the method 700 may perform a similar function as step 610 in FIG. 6.

At 714, the method 700 may perform a similar function as step 611 in FIG. 6.

At 715, the method 700 may perform a similar function as step 612 in FIG. 6.

In method 700, the completion of primary authentication may take a longer time than existing primary authentication in 5GS, since the AUSF may need to wait for the SECMF to create GSPs before completing the authentication. However, primary authentication at the AUSF and GSP creation at the SECMF may be performed in parallel in order to reduce or eliminate the impact of GSP creation on authentication timing.

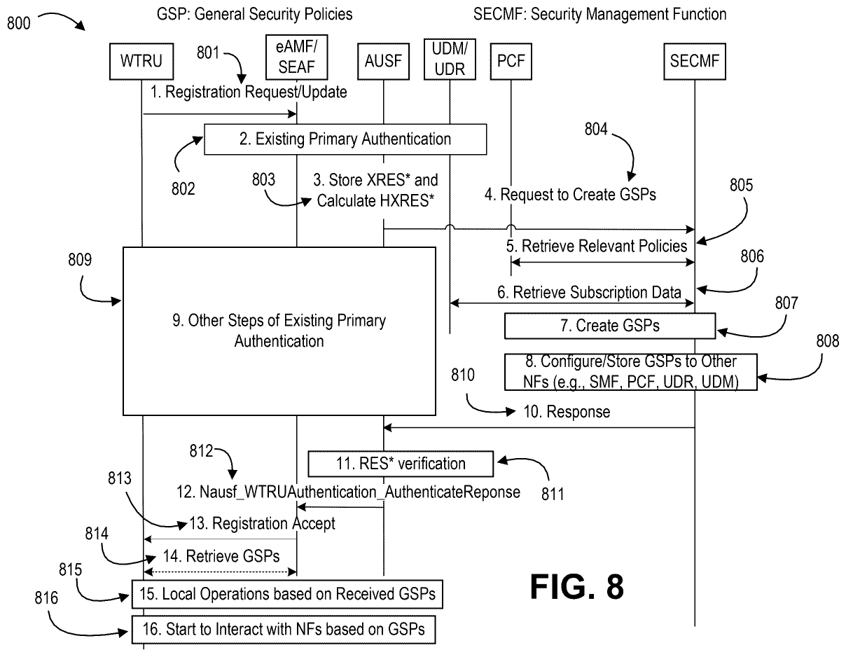

FIG. 8 illustrates a method 800 for GSP creation during primary authentication. In this approach, AUSF may trigger SECMF to create GSPs at the beginning of primary authentication. After that, SECMF may proceed to create GSPs, while AUSF may continue primary authentication concurrently. After SECMF creates GSPs, AUSF may also complete or be close to completing primary authentication. Then, AUSF may piggyback the created GSPs in a nausf_WTRUAuthentication_authenticateResponse message to be sent to eAMF/SEAF. The approach in FIG. 8 may share the same benefits as the method shown in FIG. 7 and may furthermore reduce the overall time to complete primary authentication.

The method 800 in FIG. 8 consists of the following steps: At 801, the method 800 may perform a similar function as at 701 in FIG. 7.

At 802, the method 800 may perform existing primary authentication as defined in relevant specifications, except the functions corresponding to 703, 709, 711, and 712 in FIG. 7.

At 803, AUSF may store XRES* and may calculate HXRES*, as specified in TS 33.501.

At 804, the method 800 may perform a similar function as at 705 in FIG. 7.

At 805, the method 800 may perform a similar function as at 706 in FIG. 7.

At 806, the method 800 may perform a similar function as at 707 in FIG. 7.

At 807, the method 800 may perform a similar function as at 708 in FIG. 7.

At 808, the method 800 may perform a similar function as at 709 in FIG. 7.

At 809, AUSF may begin performing other steps of existing primary authentication (excluding 711 and 712 of FIG. 7) as defined in TS 33.501. These steps may be initiated after 804 and may be completed after 808 but before 810.

At 810, the method 800 may perform a similar function as at 710 in FIG. 7. If SECMF finishes creating GSPs earlier and sends the response in 810 before AUSF completes 809, AUSF may receive the response and may store the GSPs locally. AUSF does not need to wait for completion of 810. For example, AUSF may proceed with steps 811 and 812 without waiting for 810. If AUSF receives the response from 810 after completing 812, AUSF may use a WTRU configuration update (UCU) or WTRU parameter update (UPU) procedure to push the created GSPs to the WTRU.

At 811, the method 800 may perform a similar function as at 704 in FIG. 7. If RES* verification is successful and AUSF has received GSPs, AUSF may proceed to 812. If RES* verification is successful and AUSF has not received GSPs, AUSF may wait to receive GSPs from SECMF before conducting 812. If RES* verification is unsuccessful and AUSF has received GSPs, AUSF may discard the received GSPs and proceed to 812, which will not contain any GSP. If RES* verification is unsuccessful and AUSF has not received GSPs, AUSF may send another request to SECMF to cancel GSP creation and may continue to conduct 812 without including any GSP.

At 812, the method 800 may perform a similar function as at 711 in FIG. 7.

At 813, the method 800 may perform a similar function as at 712 in FIG. 7.

At 814, the method 800 may perform a similar function as at 713 in FIG. 7.

At 815, the method 800 may perform a similar function as at 714 in FIG. 7.

At 816, the method 800 may perform a similar function as at 715 in FIG. 7.

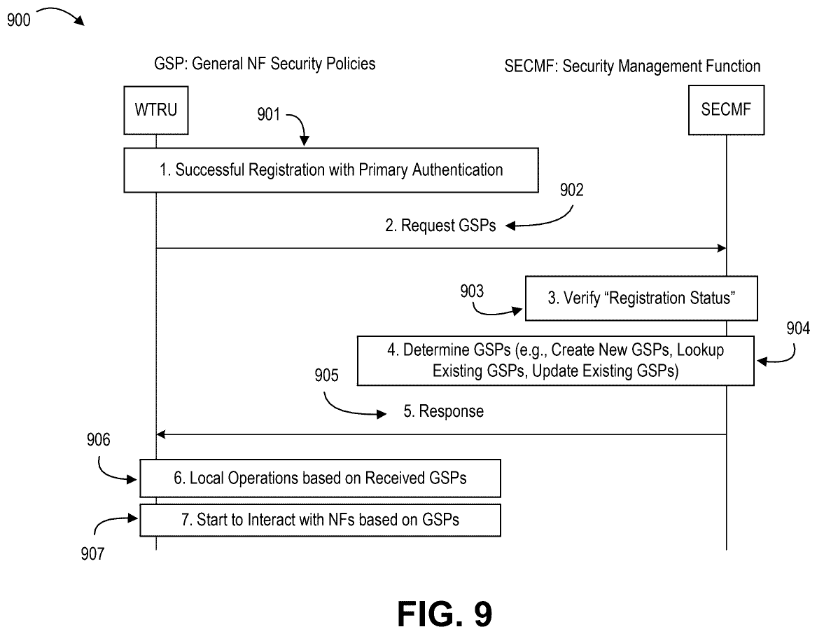

FIG. 9 illustrates a method 900 for obtaining GSPs after successful registration. After registration is successfully performed, the WTRU may actively retrieve or request GSPs from SECMF. SECMF may first verify whether the WTRU has been successfully registered. SECMF may then return requested (already created) GSPs to the WTRU and/or create new GSPs and send them to the WTRU.

This method may bring benefits as described below. It may not introduce extra messages between the WTRU and eAMF/SEAF since the creation of GSPs is requested after the completion of registration. The registration accept message may not need to contain GSPs, and its size may not be increased too much. The overall time for completing registration may not be impacted. If eAMF sends a signed registration status to the WTRU, the WTRU may use it to claim its registration status, which may avoid SECMF contacting eAMF and may reduce signaling between SECMF and eAMF.

The method 900 in FIG. 9 may include one or more of the following steps. At 901, the WTRU may have successfully registered to the network. The registration accept message sent by eAMF to the WTRU may contain the SECMF ID, which may identify the SECMF to be contacted in 902 to request GSPs. The message may also contain a list of GSP IDs corresponding to GSPs that SECMF has created for the WTRU but has not sent, for example, because the created GSPs may be too large to include in the registration accept message. The registration accept message may also contain a registration status, which may be signed by eAMF or SEAF. This registration status may indicate a successful registration and may include the WTRU ID (e.g., GUTI), a status value such as “successful” or “1” or “true,” an expiration time indicating when the registration becomes invalid, effective areas where the registration is valid, the eAMF or SEAF ID, optionally the SECMF ID, and a signature of the eAMF or SEAF generated using its private key or KSEAF.

At 902, the WTRU may send a “request GSPs” message to SECMF, such as via control plane or user plane. This message may include the WTRU ID (e.g., GUTI), the WTRU security context as described in FIG. 6, the registration status received as part of 901, and a list of GSP IDs corresponding to existing GSPs that the WTRU has already obtained, for example, from eAMF.

At 903, SECMF may receive the “request GSPs” message. SECMF may verify that the registration status is valid, for example, by checking its signature and verifying that the WTRU registration status is still “successful.” If registration status is included in the message, SECMF may be able to verify the signature directly without contacting eAMF, assuming SECMF knows the public key or secret key of the eAMF or SEAF. If registration status is not included in the message, SECMF may use the WTRU ID to locate the eAMF and may then contact eAMF to verify the registration status of the WTRU.

At 904, if the WTRU still holds a successful registration status, SECMF may create new GSPs and/or update existing GSPs for the WTRU. For this purpose, SECMF may retrieve information such as, but not limited to, existing policies from PCF, WTRU subscription data from UDM, and WTRU security context from UDR or other NFs. If the message in 902 contains a list of GSP IDs and the corresponding GSPs are still valid, SECMF may not create any new GSP but may instead include the existing GSPs in 905. This may correspond to the case where the WTRU uses the list of GSP IDs to retrieve GSPs. Even if the GSPs in the list are still valid, SECMF may still create new GSPs, and 905 may contain both newly created and existing GSPs. SECMF may also update existing GSPs, and in that case, 905 may include both updated existing GSPs and newly created GSPs.

At 905, SECMF may send a response to the WTRU, which may contain GSPs as determined, created, or updated in 904. This response may be sent over control plane or user plane.

At 906, the method 900 may perform a similar function as at 611 in FIG. 6.

At 907, the method 900 may perform a similar function as at 612 in FIG. 6.

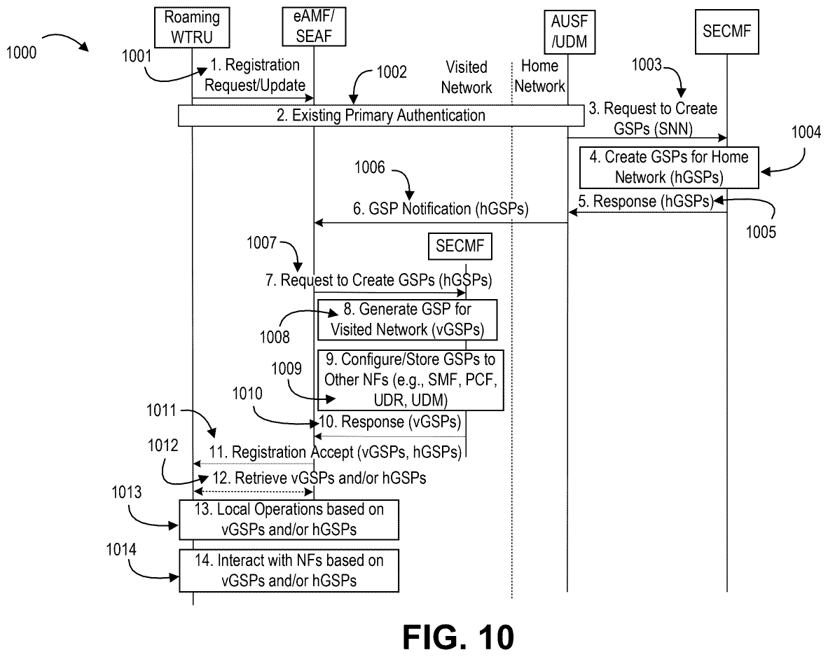

FIG. 10 illustrates a method 1000 for creating GSPs under a scenario where SECMF exists in both the home network (HN) and the visited network (VN) (e.g., Visited PLMN, Visted NPN). SECMF in HN may create GSPs for the WTRU to interact with NFs in the HN. These GSPs are referred to as hGSPs. SECMF in the VN may create GSPs for the WTRU to interact with NFs in the VN. These are referred to as vGSPs. The vGSPs may be created using the hGSPs as a reference, or the hGSPs may be used to guide the creation of the vGSPs. The vGSPs and/or hGSPs may be sent to the WTRU, for example, by eAMF/SEAF in the VN.

The method 1000 in FIG. 10 may include the following steps.

At 1001, the method 1000 may perform a similar function as at 601 in FIG. 6.

At 1002, the method 1000 may perform a similar function as at 602 in FIG. 6.

At 1003, AUSF may send a “request to create GSPs” message to SECMF. This message may contain the Serving Network Name (SNN), which is the service network name. The SNN may indicate the name or identifier of the VN. SECMF in the HN may use the SNN to determine whether the created GSPs should be more stringent or less stringent, assuming the E2E interaction between the WTRU and NFs in the HN passes through the VN. For example, since the WTRU must go through the VN, the HN may not want to expose its NFs directly to the VN. As a result, the “communication mode” in the created GSPs for the WTRU may be configured to “indirect E2E.” For the same reason, the “PQC profiles” in the created GSPs may be configured with PQC algorithms or other quantum-safe schemes that achieve higher security categories or levels, such as category 4 or 5.

At 1004, the method 1000 may perform a similar function as at 606 in FIG. 6. SECMF may retrieve existing policies from PCF (similar to 604), retrieve roaming WTRU subscription data from UDM (similar to 605), and retrieve WTRU security context from other NFs in the HN, such as UDR or NWDAF. SECMF may then create GSPs for the WTRU to access NFs in the HN based on the retrieved information. These GSPs are referred to as hGSPs.

At 1005, SECMF may send a response to AUSF, which may contain the hGSPs, the identifier of the hGSPs, the identifier of SECMF, and the identifier of the WTRU.

At 1006, AUSF may forward the hGSPs to eAMF/SEAF in a GSP notification message.

At 1007, the method 1000 may perform a similar function as at 603 in FIG. 6. eAMF/SEAF may send a “request to create GSPs” message to SECMF in the VN. This message may contain the WTRU security context, which may be a combination of the UESC received from 1001 and any additional context information eAMF/SEAF has kept for the WTRU. This message may also contain the WTRU ID, such as SUPI, SUCI, or GUTI, the identifier of eAMF and/or SEAF, the credential of eAMF and/or SEAF, and the hGSPs as received from 1006.

At 1008, the method 1000 may perform a similar function as at 606 in FIG. 6. One difference is that SECMF in the VN may use hGSPs as a reference to guide the creation of vGSPs. For example, some IEs in a GSP for Home Network (hGSP), such as the “communication mode,” may be reused in a GSP for Visited Network (vGSP). In another example, hGSPs for a specific type of NFs in the HN may be used for the same type of NFs in the VN.

At 1009, the method 1000 may perform a similar function as at 607 in FIG. 6.

At 1010, the method 1000 may perform a similar function as at 608 in FIG. 6.

At 1011, the method 1000 may perform a similar function as at 609 in FIG. 6. The registration accept message may contain both hGSPs and vGSPs. If hGSPs were only generated to guide the creation of vGSPs in 1008, hGSPs may not be included in the registration accept message. The registration accept message may contain the identifier of hGSPs, the identifier of vGSPs, the identifier of SECMF in the HN, and/or the identifier of SECMF in the VN.

At 1012, the method 1000 may perform a similar function as at 610 in FIG. 6. The WTRU may use the identifier of hGSPs to retrieve hGSPs from eAMF/SEAF and/or SECMF in the HN. The WTRU may also use the identifier of vGSPs to retrieve vGSPs from eAMF/SEAF and/or SECMF in the VN.

At 1013, the method 1000 may perform a similar function as at 611 in FIG. 6.

At 1014, the method 1000 may perform a similar function as at 612 in FIG. 6.

To enable E2E WTRU-NF communication, appropriate target NF instances that match the WTRU's requirements may need to be found. To guarantee quantum-safe WTRU-NF communication, the WTRU and the target NF instances may need to use the same PQC algorithms or Post-Quantum/Traditional Hybrid Schemes (PQ/T hybrid schemes). Although the WTRU and the target NF instances may be able to negotiate PQC algorithms using a TLS handshake, referred to as TLS-based negotiation, this approach may cause high management overhead. This is because target NF instances in 6GS are managed by MNOs, which differs from the way public internet servers (e.g., web servers) are managed.

Assume the WTRU communicates with a target NF directly over a PDU session on the user plane. SECMF is proposed as a new NF that may determine NF-specific security policies (NFSSPs) for both the WTRU, and the target NF instance involved in E2E WTRU-NF communication during the establishment of a PDU session. SECMF may create NFSSPs based on the WTRU context information and the target NF instance's profile, as well as their PQC capabilities, and may select appropriate PQC algorithms and/or PQ/T hybrid schemes for inclusion in the NFSSPs. SECMF may configure and enforce NFSSPs at both the WTRU and the target NF instance. NFSSPs may indicate the PQC algorithms and other security-related parameters that the WTRU and the target NF instance must adopt and comply with to guarantee quantum-safe E2E WTRU-NF communication.

Compared to the TLS-based approach, the SECMF-based approach may offer several advantages. Having SECMF create and manage NFSSPs may provide a more efficient and simpler way to manage security-related parameters and policies, potentially reducing management overhead for MNOs. For example, if using TLS-based negotiation, the PQC algorithms and parameters negotiated for each WTRU and NF pair would need to be monitored and reported, which may impose higher overhead than the SECMF-based approach.

If TLS-based negotiation is used, the target NF instance may not be able to make decisions on appropriate security parameters and may need to contact other NFs such as PCF or UDR. The proposed SECMF approach may reduce or eliminate the need for such additional NF interactions, as SECMF may determine policies directly. Furthermore, PCF may still be contacted during PDU session establishment.

NFSSPs may also include IEs that trigger the WTRU and the target NF instance to dynamically monitor and report the status or statistics of WTRU-NF communication. This may eliminate the need for separate procedures to initiate WTRU-NF monitoring.

In the proposed SECMF-based approach, it is assumed that the WTRU may only know its NF intent, such as the type of target NF. The WTRU may rely on the 6G network to discover target NF instances during PDU session establishment. Three scenarios are considered.

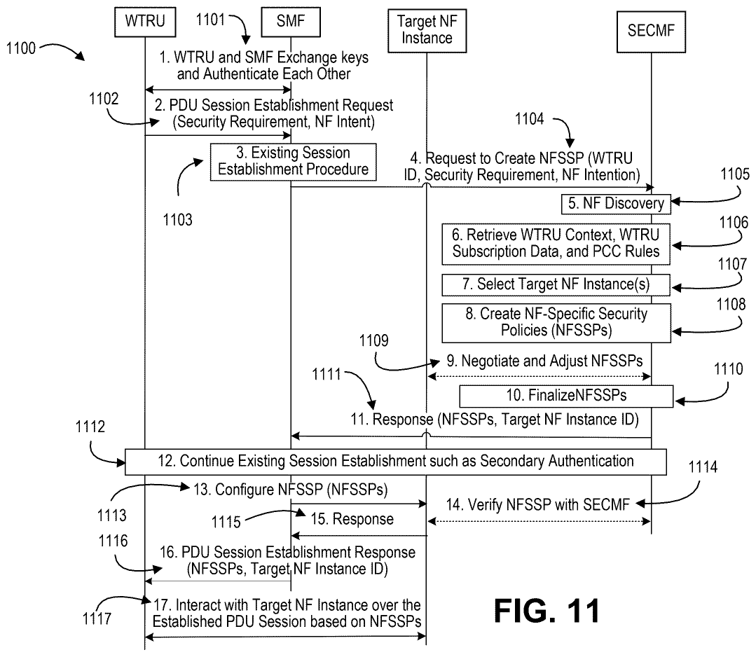

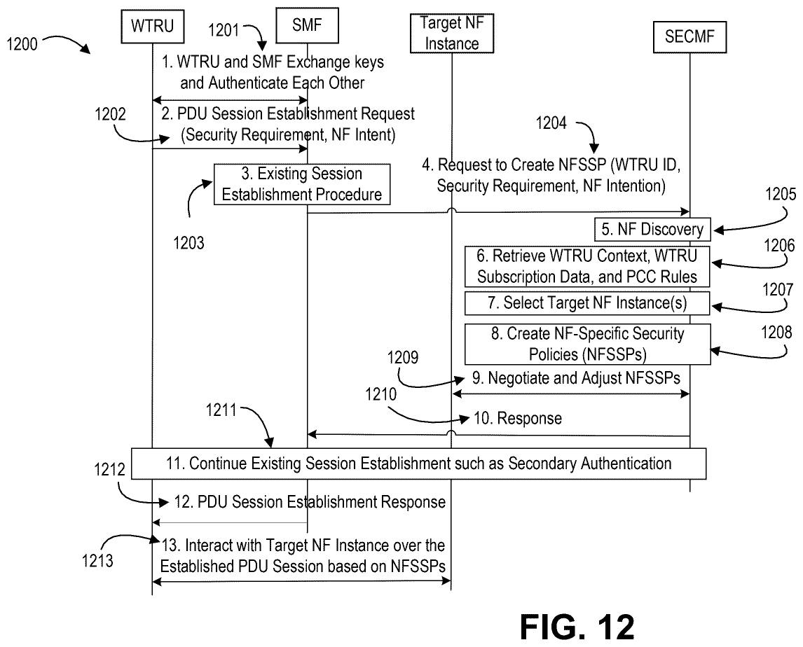

In scenario 1, SMF may pass the WTRU's NF intent to SECMF. SECMF may discover and select the target NF instances for the WTRU based on this NF intent and may create the NFSSPs, as shown in FIG. 11 and FIG. 12. This approach may minimize the impact on SMF. However, if SMF does not report QoS statistics of existing WTRU-NF interactions to SECMF, SECMF may not be able to consider QoS statistics during NFSSP creation, even though SECMF may have security context and statistics available for use.

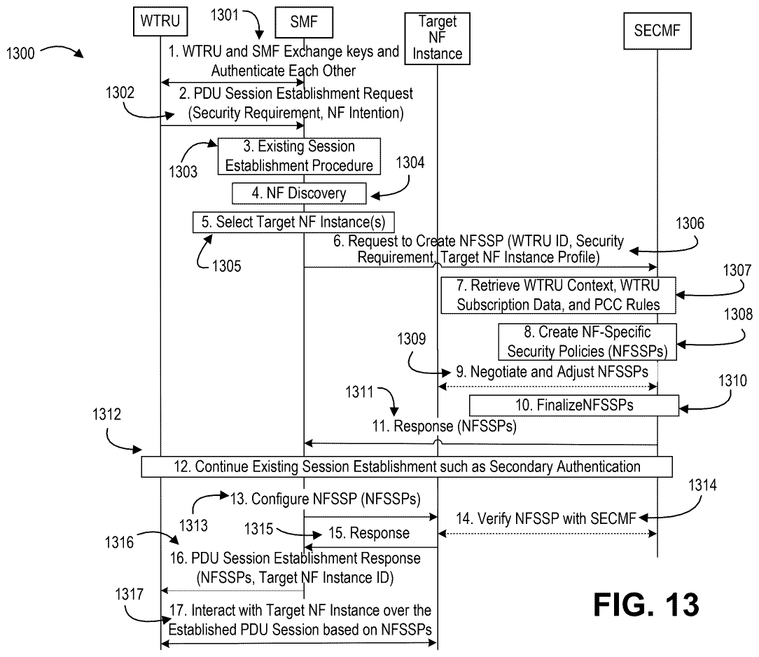

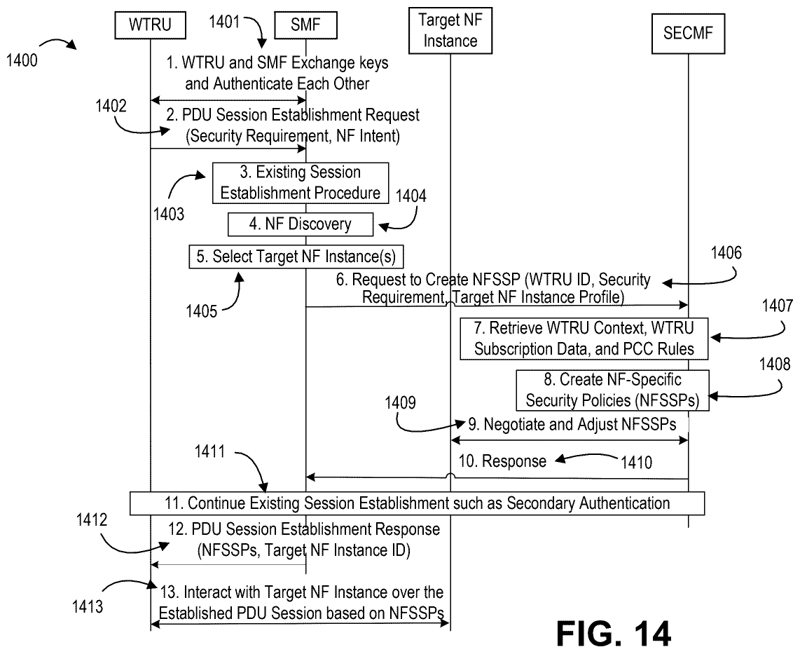

In scenario 2, SMF may discover and select the target NF instances for the WTRU based on its NF intent and may then pass the selected target NF instance to SECMF. SECMF may create the NFSSPs, as shown in FIG. 13 and FIG. 14. This approach may introduce more overhead to SMF compared to the approach in FIG. 11 and FIG. 12, since SMF needs to perform discovery and selection of target NF instances. However, SMF may avoid needing to report QoS statistics to SECMF, and the created NFSSPs may be better from a QoS perspective. On the other hand, the created NFSSPs may be worse than those in FIG. 11 if SMF lacks the security context or related statistics, which SECMF may possess.

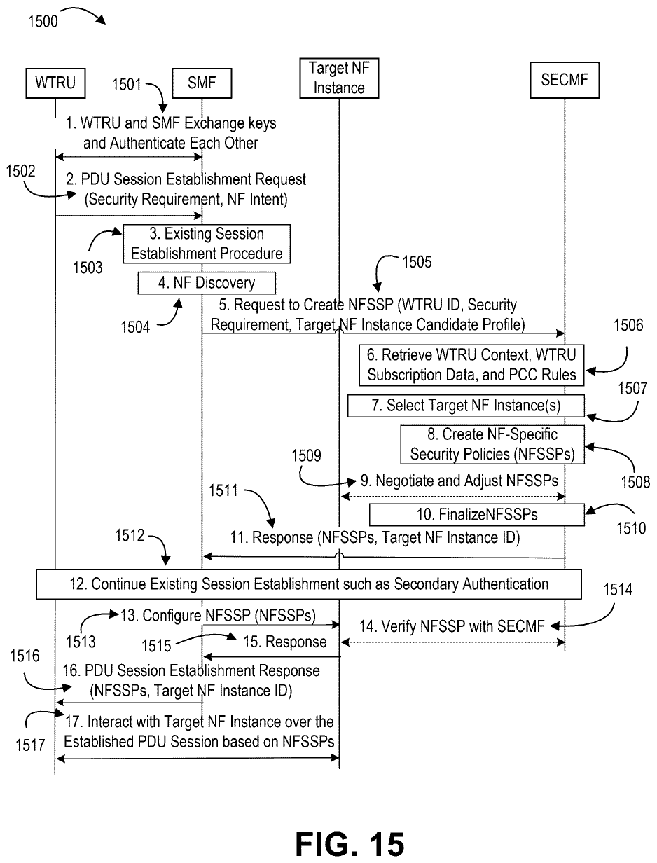

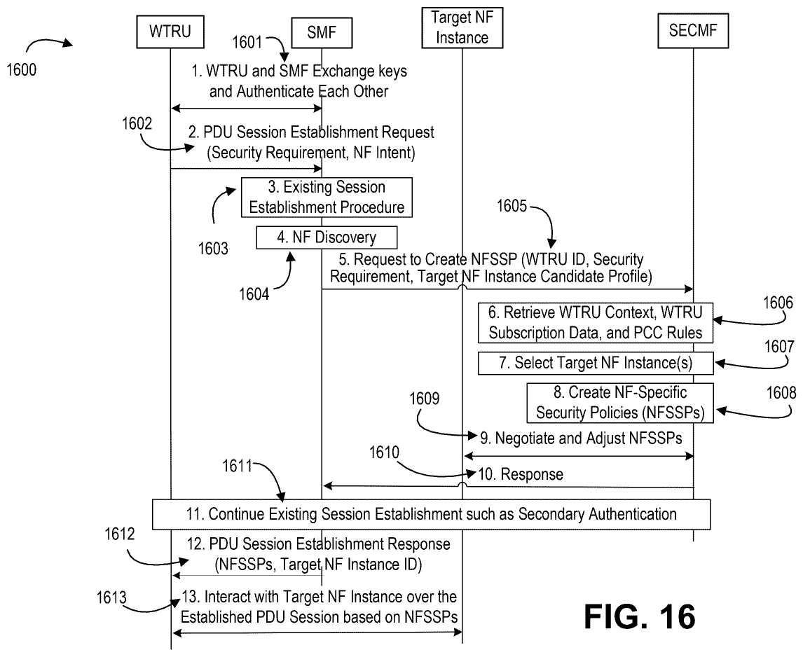

In scenario 3, SMF may discover target NF instances for the WTRU based on its NF intent and may pass candidates to SECMF. SECMF may then select the target NF instances and create NFSSPs, as shown in FIG. 15 and FIG. 16. This approach may introduce some overhead to SMF compared to the approach in FIG. 11 and FIG. 12 because of the need to discover target NF instances. However, SMF may pre-filter some target NF instances based on their QoS statistics before reporting them to SECMF.

FIG. 11 illustrates a procedure for WTRU to establish a PDU session. This may include NF instance discovery and/or selection at an SECMF. A WTRU and SMF may first authenticate each other and exchange keys directly (e.g., WTRU has received “SMF Contact Info” from eAMF) or indirectly via eAMF. Since WTRU may not know the exact target NF instance it can interact with, WTRU indicates NF Intent (e.g., NF name or NF type) in PDU session establishment request. After SMF receives PDU session establishment from WTRU, SMF requests SECMF to discover target NF instance candidates, select appropriate target NF instance(s) for WTRU, and create NF-Specific Security Policies (NFSSPs) for both WTRU and selected target NF instance(s). SECMF signs the created NFSSPs and sends them to SMF. Then, SMF configures and enforces NFSSPs to WTRU and selected target NF instance(s). Finally, WTRU contacts selected target NF instance(s) to start E2E WTRU-NF communication according to the configured NFSSPs. SMF on this procedure may be an evolved SMF (eSMF) supporting 6GS, which may be able to support indirect communication with WTRU via AMF (in 5GS) and/or direct communication with WTRU without relaying via AMF (in 6GS). Note that the WTRU may establish multiple PDU sessions with the same target NF instance.

At 1101, WTRU and SMF may use existing NAS security for exchanging NAS SM messages (e.g., 1102, 1112, and 1116) via AMF. Alternatively, and/or additionally, WTRU and SMF may interact with each other directly without passing through AMF. In this case, WTRU and SMF may first authenticate each other and exchange keys for providing quantum-safe communications between WTRU and SMF. Assume WTRU has obtained information or instructions (e.g., “SMF Contact Info” from another NF such as AMF) about authentication schemes and key exchange schemes.

For example, another NF may have informed the identifier, Application Programming Interface (API) info, IP address, Transmission Control Protocol (TCP)/User Datagram Protocol (UDP) port and/or other contact info about SMF so that WTRU may be able to contact SMF directly. Otherwise, WTRU may contact SMF indirectly via AMF.

For example, another NF may have informed WTRU that it needs to send its certificate or credential to SMF for authenticating itself. As such, WTRU may attach its certificate or credential in the first message to be sent to SMF.

For example, another NF may have informed WTRU that it needs to exchange a shared key with SMF using a specific version of a PQC algorithm (e.g., ML-KEM-512). To this end, WTRU may use SMF's public key as the encapsulation key in ML-KEM to encapsulate the shared key to generate a ciphertext and send the ciphertext to SMF. SMF will use its private key as a decapsulation key in ML-KEM to decode the shared key from the ciphertext.

At 1102, assume end-to-end WTRU-NF communication is through one or multiple PDU sessions, referred to as WTRU-NF communication PDU session. WTRU sends a PDU session establishment request to SMF, which also could be a PDU session modification request to add other target NFs to communicate with using a single WTRU-NF communication PDU session. This request may be encrypted according to one or more designated confidentiality protection schemes and may also be signed according to one or more designated integrity protection schemes. Another NF (e.g., AMF) may have informed WTRU, via a registration accept message, the list of designated confidentiality protection schemes and a list of integrity protection schemes for WTRU to use for communicating with SMF. DNN in this request may be set to “E2E WTRU-NF communication”, “A NF Name or Type (e.g., UPMF)” or other values to indicate the PDU session to be established is not for traditional data network but for E2E WTRU-NF interaction. This request may contain the following IEs. Other IEs not described below but defined for PDU session establishment request may also be contained in this request.

QoS requirements may indicate QoS requirements or 5G QoS Identifier (5QI) for the PDU session to be established. SECMF may leverage QoS requirements to determine appropriate PQC algorithms for WTRU and target NF instance. For example, if QoS requirements indicate a small or stringent packet delay budget, a PQC algorithm with lower computation and lower communication overhead (e.g., shorter ciphertext, shorter signature) may be preferred over other PQC algorithms to reduce latency caused by PQC algorithms.

Security requirements may indicate security requirements about E2E WTRU-NF communication or about the PDU session to be established from WTRU perspective. This IE may comprise the following IEs.

Security level may indicate the required security level or security category. This IE may indicate a specific security level or a range of security levels.

Confidentiality protection may indicate WTRU's requirement on encrypted communication on uplink (i.e., from WTRU to target NF instance) and/or downlink (i.e., from target NF instance to WTRU). This IE may indicate two sets of parameters (e.g., one set for uplink and one set for downlink). For each set, this IE may simply indicate yes (need confidentiality protection) or no (no need for confidentiality protection). For each set, this IE may comprise one or more than one confidentiality protection schemes indicating that any one of these schemes is good for WTRU.

Integrity protection may indicate WTRU's requirement on communication integrity protection for uplink and/or downlink. This IE may indicate two sets of parameters. For each set, this IE may simply indicate yes or no. For each set, this IE may comprise one or more than one integrity protection schemes (e.g., PQC digital signature algorithms, classical digital signature schemes, and/or classical MAC schemes) indicating that any one of these schemes is good for WTRU.

Target NF authentication schemes may indicate the authentication schemes (e.g., certificate-based, credential-based) that WTRU supports to authenticate target NF instance. If this IE is not included or indicates none of the authentication schemes, it may imply that WTRU does not need to authenticate target NF instance.

WTRU context may indicate WTRU context and/or UESC. WTRU context may have been maintained in other NFs (e.g., AMF, UDR, UDM, User Profile Management Function (UPMF), LMF). In this case, this IE may be optional. This IE may comprise the following IEs.

Location may indicate the current location of WTRU.

Access network type may indicate the type of access network WTRU is using for contacting SMF.

PQC capability may indicate the supported PQC algorithms (e.g., ML-KEM, HQC, ML-DSA, SLH-DSA, FN-DSA) and other quantum-safe capability (e.g., QKD).

Non-PQC capability may indicate the supported non-PQC or non-quantum cryptography schemes (e.g., classical or conventional key exchange schemes, classical or conventional confidentiality protection schemes, classical or conventional integrity schemes).

User ID may indicate the identifier of a human user using WTRU and/or the identifier of the application on WTRU which will interact with target NF instance using E2E WTRU-NF communication.

Previous NFSSP ID may indicate the identifier of one or multiple previous NFSSPs that WTRU has received in previous registration accept and they may be still valid or not expired.

NF intent may indicate the type and/or subtype or the name and/or subname of target NF that WTRU intends to interact with via E2E WTRU-NF communication. At this moment, WTRU or the user may not know the exact target NF instance but only its intent. This IE may contain user-level intent described in a natural language phrase (e.g., “I would like to contact a data analytics network function directly”). In this case, SMF may use an embedded native Large Language Model (LLM model) or a native generative AI model or leverage an LLM model or generative AI model provided by other NFs to interpret user-level intent and decode NF type or name as requested by WTRU. In many cases, this IE may just indicate one type or one name of target NF. Thus, only one target NF instance will be discovered and selected and in turn maybe only one PDU session will be established. NF intent may also indicate desired outputs that WTRU may expect from target NFs. There are some cases for indicating more than one type or name of target NFs. In some cases, NF intent may also indicate target NF instance(s).

In Case 1, for independent multiple NF types, WTRU knows it will use and contact AI-related NF (one type) and compute-related NF (another type). Instead of using two separate PDU session establishment requests sequentially, WTRU uses one request to indicate both NF types and request two PDU sessions (one for each NF type). Also, SECMF will generate two sets of NFSSPs, one for each NF type.

In Case 2, for chained multiple NF types, WTRU may have a data set (e.g., images). Each image has no label or description. There might be some duplicated images. Some images (e.g., image about the user of WTRU) may have privacy concern. WTRU wants to leverage NFs in 6GS to process, analyze, use, and share this image set. For example:

WTRU first needs a data preprocessing NF (the first target NF) to filter out duplicated images and images with privacy concern.

Then, WTRU needs a data analytics NF to detect objects on images and add label to each image.

Then, WTRU needs a model training NF to use the labeled images to train or retrain an AI or ML model.

Last, WTRU needs a data sharing NF (the last target NF) to host the labeled image set and trained AI or ML model and make them available to share with other WTRUs and/or applications.

In this case, the NF intent of WTRU is about to use four different types of target NFs and chain them together. There are two approaches to support this intent and the WTRU may indicate its preference on each of the two approaches as a part of NF intent.

In one example, a SMF may create four separate PDU sessions, one for each type. Then, WTRU needs to use each PDU session to contact each type of target NF, like case 1. This approach increases the overhead at WTRU, since WTRU needs to collect outputs from one target NF and feed them back to the next target NF as inputs.

In approach II, SMF may first establish one PDU session between WTRU and the first target NF (e.g., data preprocessing NF). Then, SMF needs to configure and cascade all four target NFs as a chain. SMF may establish another PDU session between WTRU and the last target NF (e.g., data sharing) which may send data sharing response or result to the WTRU via this another PDU session.

At 1103, SMF receives the PDU session establishment request from step 2. SMF performs some operations of existing session establishment procedure as defined for PDU session establishment. For example, SMF may check with PCF for any applicable PCC rules based on WTRU ID and NF intent.

At 1104, SMF may be provisioned with the identifier and/or address of SECMF. SMF may discover SECMF from NRF, which can manage security policies for the WTRU and the indicated type of target NF. Then, SMF sends a “request to create NFSSP” message to SECMF. This message may contain the following IEs: WTRU ID, such as a SUPI or GUTI; user ID as received from 1102; the security requirements as received from 1102; the NF intent as received from 1102; the WTRU context as received from 1102; the PCC rules (or just the identifier of those PCC rules) that SMF has obtained as part of 1103; and some other IEs contained in the PDU session establishment request in 1102.

At 1105, SECMF performs NF discovery to discover target NF instance candidates. For example, SECMF may send some IEs as received from 1104, such as WTRU ID and NF intent, to NRF. NRF uses such IEs to look up target NF instance candidates that match those IEs, such as the NF intent. NRF sends a list of found target NF instance candidates, including their profiles, to SECMF. The profile of each target NF instance (i.e., target NF profile) may include their identifier, service Key Performance Indicator (KPIs) such as throughput, processing latency, waiting time, the number of serving WTRUs or consumers, service capability and context such as unoccupied storage, remaining compute resource, unused memory, location such as whether the instance is hosted within the Mobile Network Operator's (MNO's) network or in a cloud, and security capability or security parameters such as their PQC capability (e.g., supported PQC algorithms).

The security capability of each target NF instance candidate may contain the following IEs.

Supported security level may indicate the supported security level or security category. This IE may indicate a specific security level or a range of security levels.

The supported E2E security protocol layer may indicate the protocol layer that supports end-to-end security, such as the IP layer or transport layer or NF service layer. The value of this IE may be IP layer or IPsec, transport layer or Transport Layer Security (TLS) or Datagram TLS (DTLS), or network function (NF) service layer. The value of this information element (IE) may impact other IEs such as supported key exchange schemes, supported confidentiality protection, and supported integrity protection.

Supported key exchange schemes may indicate supported key exchange schemes. More than one key exchange scheme may be composed in this IE. A key exchange scheme may include classical schemes such as DH, RSA, Elliptic Curve Diffie-Hellman (ECDH), Elliptic Curve Diffie-Hellman Ephemeral (ECDHE), SRP, Kerberos, AKE, Menezes-Qu-Vanstone (MQV); PQC schemes such as ML-KEM, HQC; quantum schemes such as QKD; or no key exchange scheme where key derivation is based on similar schemes and keying materials in 5GS such as based on KSEAF.

Supported confidentiality protection may indicate support for encrypted communication on the uplink, from WTRU to the target NF instance, and/or downlink, from the target NF instance to the WTRU. This IE may include two sets of parameters, one for uplink and one for downlink. Each set may comprise one or more supported confidentiality protection schemes.

Supported integrity protection may indicate support for communication integrity protection on uplink and/or downlink. Each set may comprise one or more supported integrity protection schemes, including PQC digital signature algorithms, classical digital signature schemes, and/or classical MAC schemes.

WTRU authentication schemes may indicate the authentication schemes, such as certificate-based or credential-based, that the target NF instance candidate supports to authenticate the WTRU. It is assumed that a target NF always needs to authenticate the WTRU.

Additionally, and/or alternatively, the NFs may register their security capabilities with the NRF. The SECMF performs discovery with the NRF of candidate NFs that match the security capabilities requested by SECMF.

At 1106, SECMF may retrieve WTRU subscription data from UDM, relevant policies or PCC rules from PCF/UDR, and WTRU context from NFs such as AMF. SECMF may also retrieve QoS statistics of ongoing E2E WTRU-NF interactions that each target NF instance candidate currently has with other WTRUs from SMF.

At 1107, SECMF selects a target NF instance for the WTRU based on IEs received from SMF and NRF, information retrieved as part of 1106, security context and/or security-related statistics about the target NF instance candidates that SECMF may have maintained locally or has access to, and other relevant information.

For example, SECMF may match the target NF profile with the NF intent and/or the security requirements of the WTRU. SECMF needs to ensure that both the WTRU and the selected NF instance can support the same PQC algorithms and other security schemes.

SECMF may select one target NF instance or more than one target NF instances for the WTRU, as requested or indicated in the NF intent.

Note that if no target NF instance was discovered in 1105 or selected in 1107, steps 1108 through 1110 and steps 1112 through 1115 may be skipped. In this case, SECMF may indicate “no target NF instance found” in 1111. As a result, SMF may reject the WTRU's request from 1102 and send the rejection with a reason “no target NF instance found” to the WTRU in 1116. Therefore, 1117 may also be skipped.

At 1108, the method may include creating NFSSPs for each selected target NF instance and for the WTRU based on information such as, but not limited to, the IEs received at step 1104, the Target NF Profiles of the selected target NF instances, the IEs retrieved at step 1106, any security context or security-related statistics about the selected target NF instances that SECMF may have maintained locally or has access to, and any rules or policies maintained by SECMF. When creating an NFSSP, SECMF may choose a post-quantum cryptography (PQC) algorithm with a lower security level, as long as that level satisfies the requirements of both the affected WTRU and the target NF instance, in order to reduce the latency introduced by the PQC algorithm. On the other hand, if the affected WTRU or the target NF instance has requested a higher security level, SECMF may select a higher-security-level PQC algorithm, even if it results in higher latency.

An IE may indicate the identifier of the NFSSP. An IE may indicate the identifier of SECMF that created the NFSSP. An IE may indicate the priority of the NFSSP, expressed as a positive integer, where a larger number indicates a higher priority and a higher-priority NFSSP overwrites one with lower priority.

An IE may indicate the target NF instances to which the NFSSP applies. This IE may include a set of IEs, with each set describing a different target NF instance. Each set may include the identifier of the target NF instance and contact information such as its IP address and TCP/UDP port number, URL, fully qualified domain name (FQDN), or API information. Each set may further include the type and subtype of the target NF instance, locations or areas or regions where the NFSSP is applicable when the instance is operating in those regions, and the public key of the target NF instance.

An IE may indicate the affected WTRU to which the NFSSP applies and at which the policy will be enforced. This may include the WTRU that sent the PDU session establishment request at step 1102. This IE may comprise the identifier of the affected WTRU (e.g., SUPI, SUCI, or GUTI), the identifiers of users associated with the affected WTRU, the locations or areas where the NFSSP should be enforced when the WTRU or its associated users are present, relevant WTRU context information such as time, access network type, or other connectivity-level information, and the public key of the WTRU.

An IE may indicate a shared secret key to be used between the affected WTRU and the target NF instance(s). The shared key may be generated directly by SECMF. Alternatively, SECMF may send the identifier of the affected WTRU and the identifier of the target NF instance(s) to a network function such as the Authentication Server Function (AUSF), Policy Control Function (PCF), or a key management function, which may then generate and securely distribute the key to SECMF. SECMF may distribute the shared key independently or together with other IEs of the NFSSP to the affected WTRU, prior to SMF sending a PDU session establishment or modification response. This distribution may occur via a secure NAS) transport using, for example, a symmetric encryption algorithm or a PQC algorithm such as ML-KEM, or via a secure PDU session between the WTRU and SECMF. SECMF may also distribute the shared key to the target NF instance either as part of step 1109 or shortly thereafter, using a secure service-based interface (SBI) protected by a symmetric or PQC encryption algorithm such as ML-KEM.

An IE may indicate the communication mode between the affected WTRU and the target NF instance. The communication mode may be one of the following: direct end-to-end (E2E), in which the target NF instance allows direct E2E communication with the affected WTRU; indirect E2E, in which the target NF instance only allows indirect E2E communication (e.g., via Service Communication Proxy (SCP) or Network Function Exposure (NEF)); or non-E2E, in which neither direct nor indirect E2E communication is permitted, and the access and mobility function (eAMF) is the sole anchor point for forwarding messages between the WTRU and the target NF instance.

An IE may indicate the identifier of an SCP that supports indirect E2E communication. An IE may indicate the identifier of a NEF that supports indirect E2E communication. An IE may indicate the identifier of an eAMF that supports non-E2E communication via the control plane. An IE may indicate the communication plane to be used for E2E WTRU-NF communication, such as the control plane, user plane, data plane, intelligence or AI plane, or computation plane.

An IE may indicate information about the PDU session being established, and to which the “Security Policies” IE will apply. This information may be added by SMF after step 1112 and before step 1113. This IE may include the identifier of the PDU session and additional information about each Quality of Service (QoS) flow. SMF may create one or more QoS flows within the PDU session and may assign each target NF instance to a different QoS flow. This IE may comprise sets of IEs with each set corresponding to a specific QoS flow. Each set may include the 5G QoS Identifier (5QI) or QoS Flow Identifier (QFI) and the identifier of the target NF instance assigned to the flow, along with contact information such as its IP address, TCP/UDP port number, URL, FQDN, or API information.

An IE may indicate the Secondary Authentication Mode, which specifies how the secondary authentication in Step 1112 should be performed. For example, SECMF may designate itself or an AUSF to act as an AAA-Server. This IE may be removed by SMF after Step 1112.

An IE may indicate NF Service Info. The target NF instance may support a list of services. This IE may indicate the list of services of the target NF instance that the NFSSP applies to. The set of service-specific IEs may include a Service ID, which may be the identifier of a service supported by the target NF instance. The set of service-specific IEs may include a Security Policy ID, which may be the identifier of a security policy that should be enforced for the corresponding service.

An IE may indicate Security Policies. These policies and rules govern the communication between the affected WTRU and the target NF instance and should be enforced at and complied with by both entities to ensure quantum-safe end-to-end communication. This IE may comprise a set of policy-specific IEs. The set may include a Security Policy ID, which may be the identifier of a security policy. The set may include a Designated Security Level, which may be the designated security level or security category and may indicate a specific level or a range of levels for end-to-end WTRU-NF interaction. The set may include a Designated WTRU-NF E2E Security Protocol Layer, which may indicate the designated protocol layer to implement and enforce end-to-end security for WTRU-NF communication. The value of this IE may be “IP Layer or IPsec,” “Transport Layer or Transport Layer Security (TLS) or Datagram TLS (DTSL),” or “NF Service Layer.” The value of this IE may impact the Designated WTRU-NF Key Exchange Scheme(s), the Designated WTRU-NF Confidentiality Protection, the Designated WTRU-NF Integrity Protection, and so on.

The set may include a Designated WTRU-NF Authentication Mode, which may indicate one of the following authentication modes: (1) only the target NF instance authenticates the affected WTRU, (2) the target NF instance and the affected WTRU mutually authenticate each other, or (3) only the affected WTRU authenticates the target NF instance, although this mode may be rarely used. The set may include a Designated WTRU-NF Authentication Scheme, which may indicate a credential-based authentication, token-based authentication, certificate-based authentication (e.g., mutual TLS), multi-factor authentication, or other schemes appropriate for the designated authentication mode.

The set may include Designated WTRU-NF Key Exchange Scheme(s), which may indicate one or more schemes used to exchange secret keys between the affected WTRU and the target NF instance. The WTRU and the target NF instance may exchange multiple secret keys, for example, one for confidentiality protection and one for integrity protection. The key exchange schemes may include classical schemes (e.g., DH, RSA, ECDH, ECDHE, SRP, Kerberos, AKE, MQV), post-quantum cryptographic (PQC) schemes (e.g., ML-KEM, HQC), quantum schemes (e.g., QKD), or no key exchange scheme (e.g., based on key derivation schemes using keying material in 5GS such as derived from KSEAF). This IE may indicate a hybrid scheme that uses both a classical and a PQC scheme for key exchange.

The set may include Designated WTRU-NF Confidentiality Protection Scheme(s), which may indicate the scheme or schemes to be used to protect the confidentiality of communication between the affected WTRU and the target NF instance. The schemes may include symmetric encryption algorithms (e.g., AES, DES, 3DES, RC4), asymmetric encryption algorithms (e.g., ECC, lattice-based cryptography), or hybrid encryption algorithms (e.g., Elliptic Curve Integrated Encryption Scheme (ECIES). This Information Element (IE) may indicate that multiple keys obtained from key exchanges are used to derive a new secret key via a key derivation function, and that new key is then used for confidentiality protection.

The set may include Designated WTRU-NF Integrity Protection Scheme(s), which may indicate the scheme or schemes to be used to protect the integrity of communication between the affected WTRU and the target NF instance. These may include Message Authentication Code (MAC) algorithms that use a shared secret key, such as hash-based MAC; digital signature schemes using asymmetric cryptography, such as classical schemes (e.g., RSA, DSA, ECDSA, EdDSA); and PQC digital signature schemes (e.g., ML-DSA, SLH-DSA, FN-DSA). This IE may indicate a hybrid scheme that uses both a classical and a PQC digital signature algorithm.

An IE may indicate the Creation Time of the NFSSP.

An IE may indicate the Enforcement Schedule of the NFSSP. The enforcement schedule may contain one or more enforcement time windows. Each time window may include a start time and a completion time. The total enforcement schedule should fall between the Creation Time and the Expiration Time.

An IE may indicate the Expiration Time of the NFSSP.

An IE may indicate a List of Security Monitoring Events at WTRU. This list specifies events that must be monitored at the affected WTRU under this NFSSP. The list may include, but is not limited to, the following events: failure of running a specific PQC algorithm, failure of contacting the target NF instance using the designated Communication Mode and Communication Plane, failure of contacting the target NF instance via a Service Communication Proxy (SCP) or Network Function Exposure (NEF), successful authentication with the target NF instance, successful receipt of a response from the target NF instance, change of access network, change to be relayed by a relay WTRU to the network, movement to a specific location or area, and update of capability to support new and/or different PQC algorithms.

An IE may indicate a List of Security Monitoring Events at the Target NF Instance. This list specifies events to be monitored at the target NF instance under this NFSSP. The list may include, but is not limited to, the following events: failure of running a specific PQC algorithm, failure of responding to the affected WTRU via a Service Communication Proxy (SCP) or a Network Function Exposure (NEF), successful authentication with the affected WTRU, successful receipt of a request from the affected WTRU, successful sending of a response to the affected WTRU, migration of the target NF instance (e.g., from the MNO's network to a cloud environment), a number of requests from the affected WTRU exceeding a defined threshold or falling within a specified range, the service KPIs falling below a threshold or within a range, the service capability falling below a certain threshold, and an update of capability to support new and/or different PQC algorithms.

An IE may indicate WTRU Security Monitoring Report Generation and Notification. This IE indicates that the affected WTRU should generate a WTRU security monitoring report, and which entity should be notified of the generated report.

An IE may indicate Report Generation Mode, which specifies how and when the WTRU security monitoring report should be generated. This IE may have the following values. One Event (or Instant): each time an event from the List of Security Monitoring Events at WTRU occurs, the affected WTRU generates a security monitoring report. K Events: only when K such events occur, the affected WTRU generates a single report containing those K events. Periodical: the affected WTRU generates a report repeatedly after a specified time period.

An IE may indicate the Target NF Instance ID, which is the identifier of the target NF instance that the affected WTRU interacts with. An IE may indicate the NFSSP Creator, which is the identifier of the NF that created the NFSSP. An IE may indicate the NFSSP ID, which is the identifier of the NFSSP. An IE may indicate the Report Recipient ID, which is the identifier of the NF that should receive the WTRU security monitoring reports (e.g., the NFSSP Creator), and/or an NF that can analyze the reports locally to adjust or generate new NFSSPs. Alternatively, the NFSSP Creator may use this IE to indicate an NWDAF instance to receive WTRU security monitoring reports. The NWDAF instance can analyze the reports and generate a summary to be sent to the NFSSP Creator.

An IE may indicate NF Security Monitoring Report Generation and Notification. This IE indicates that the target NF instance should generate WTRU security monitoring reports, and which entity should be notified of the generated reports.

An IE may indicate report generation mode for the NF, specifying how and when a security monitoring report should be generated. This IE may have the following values. One Event (or Instant): each time an event from the List of Security Monitoring Events at Target NF Instance occurs, the target NF instance generates a report. M Events: only when M such events occur, the target NF instance generates a report containing those M events. Periodical: the target NF instance generates reports repeatedly after a specified period.

An IE may indicate the Affected WTRU ID, which is the identifier of the affected WTRU interacting with the target NF instance. An IE may indicate the NFSSP Creator, the NFSSP ID, and the Report Recipient ID, all with the same semantics as previously described. The Report Recipient ID may be the NFSSP Creator or an NWDAF instance designated to receive the reports, analyze them, and generate summaries for the NFSSP Creator.

An IE may indicate SECMF Signature, which is the digital signature of SECMF that created the NFSSP. SECMF may sign the NFSSP using its private key according to a PQC digital signature algorithm (e.g., ML-DSA-65) and/or a classical non-PQC digital signature algorithm (e.g., ECDSA).

TABLE 3

| IEs | Values (As an example) |
|---|---|
| NFSSP ID | “NFSSP-001” |
| NFSSP Creator | “SECMF-001” |
| Target NF Instance -> NF ID | “NWDAF-001” |
| Target NF Instance -> NF Type | “Data-related NFs” |
| Target NF Instance -> NF Subtype | “NWDAF” |
| Target NF Instance -> NF Location | “Cloud” |
| Communication Mode | “Indirect E2E” |
| SCP ID | “SCP-001” |
| Affected WTRU ->WTRU ID | “WTRU-001” |
| Affected WTRU -> Access Network Type | “Terrestrial Network” |
| Communication Plane | “User Plane” |
| Secondary Authentication Mode | “SECMF as AAA-Server” |
| Security Policies ->Designated WTRU-NF | “TLS” |
| E2E Security Protocol Layer | |
| Security Policies -> Designated WTRU-NF | “NF Authenticates WTRU” |
| Authentication Mode | |
| Security Policies -> Designated WTRU-NF | “Multi-Factor Authentication” |
| Authentication Scheme | |
| Security Policies -> Designated WTRU-NF | “ML-KEM-512” |
| Key ExchangeScheme | |
| Security Policies -> Designated Confidentiality | “AES-128” |
| Protection Scheme | |
| Security Policies -> Designated Integrity | “FN-DSA-512” |
| Protection Scheme | |
| SECMF Signature | “0x57ec7fe4c97b893c9103be76f2c017c0d34388584f” |

Table 3 illustrates an NFSSP example that includes the following information and policies.

In this example, the NFSSP is created for WTRU-001 and NWDAF-001 at Mar. 18, 2025 3:25:41 PM by SECMF-001. SECMF-001 signs the NFSSP with the signature “0x57ec7fe4c97b893c9103be76f2c017c0d34388584f”. WTRU-001 can communicate with NWDAF-001 directly under the following conditions: when WTRU-001 is located within City-001; when WTRU-001 accesses the 6GS through a terrestrial network (not through a satellite network); and when NWDAF-001 is deployed within the MNO's own network. The indirect end-to-end WTRU-NF communication between WTRU-001 and NWDAF-001 must be performed through the user plane. The communication between WTRU-001 and NWDAF-001 must be protected using the following schemes, including PQC algorithms to meet security level 1: transport layer security (TLS) must be enforced; NWDAF-001 must authenticate WTRU-001 using multi-factor authentication; shared secret keys must be exchanged using the PQC algorithm ML-KEM-512; AES-128 must be used to encrypt communication; and FN-DSA-512 may be used to protect communication integrity.

SECMF may send the created NFSSPs (either partially or in full) to the target NF instance to allow it to propose modifications. For example, the target NF instance may add or update NF Service Info and/or other IEs within the NFSSP. The target NF instance may respond with updated NFSSPs or a simple “Agree Indication” to SECMF. SECMF and the target NF instance may interact over several rounds of request/response-based negotiation to finalize the NFSSPs. This step is optional.

SECMF finalizes the NFSSPs based on the feedback or suggested modifications received from the target NF instance.

SECMF sends a response to SMF. This response may comprise the following IEs. One IE may include the full set of NFSSPs as generated in the earlier step. One IE may include a list of NFSSP IDs indicating the identifiers of the NFSSPs created. This IE may be omitted if the NFSSPs are included. Another IE may indicate Target NF Instance Info, which includes the following. Target NF Instance ID: the identifier of the target NF instance selected earlier. This IE may also be optional if the NFSSPs are present. NFSSP Notification to Target NF Instance: this IE may indicate whether SMF is responsible for configuring the NFSSPs to the target NF instance in Step 1113. If SECMF has already negotiated with the target NF instance, this IE may indicate “NO,” showing that Steps 1113 through 1115 for this target NF instance may be skipped.

SMF may receive the response from Step 1111 and determines the selected target NF instance(s). SMF continues with the standard PDU session establishment procedure via Step 1112, which may include performing secondary authentication with the target NF instance according to the Secondary Authentication Mode in the NFSSPs, determining the 5QI for the default QoS flow of the session, determining QoS rules and profiles, configuring them to the RAN, determining packet detection rules, and configuring them to the UPF, as defined for 5GS and 6GS.

If multiple target NF instances were selected and reported in Step 1111, SMF may repeat Step 1112 for each target NF instance. A separate QoS flow may be created for each target NF instance. Similarly, Steps 1113 to 1115 may be repeated for each selected target NF instance.

SMF may send a request to configure NFSSPs to the target NF instance. Certain IEs in the NFSSPs may be applicable only to the WTRU and may be removed before sending to the target NF instance—for example, List of Security Monitoring Events at WTRU and WTRU Security Monitoring Report Generation and Notification. Each NFSSP contains the identifier of the WTRU, enabling the target NF instance to recognize future incoming requests from the WTRU.

The target NF instance receives the NFSSPs from SMF and may verify the NFSSPs by checking the SECMF Signature contained in each one. Optionally, it may contact SECMF directly for verification.

After verifying the NFSSPs, the target NF instance sends a response to SMF. This response may indicate whether the verification was successful or failed.

SMF may send a PDU session establishment response or PDU session modification response to the WTRU via Step 1116. This response may include the NFSSPs, and any other IEs required by the PDU session establishment response format. The identifier of the target NF instance (Target NF Instance ID) may also be included in this step, although the WTRU can alternatively extract it from the NFSSPs.

Certain IEs in the NFSSPs may apply only to the target NF instance and may be removed before being sent to the WTRU—for example, List of Security Monitoring Events at Target NF Instance and NF Security Monitoring Report Generation and Notification.

SMF may also establish a second, dedicated PDU session to enable the WTRU to access security policy-related services from SECMF. In that case, the response may indicate that two PDU sessions are being established: one for WTRU-to-target-NF-instance communication, and one for WTRU-to-SECMF communication.

The WTRU may receive the PDU session establishment response from SMF. It extracts the NFSSPs, verifies them (e.g., using SECMF's public key), and stores valid NFSSPs locally. The WTRU receives the Target NF Instance ID either directly or via the NFSSPs. The WTRU may determine PQC algorithms and/or classical cryptographic algorithms to be used for the communication with the target NF instance according to NFSSPs; for example, if an NFSSP specifies or designates only one PQC algorithm for the WTRU to use and enforce, the WTRU may choose and determine to use this PQC algorithm; in another example, if an NFSSP may specify and designate multiple PQC algorithms and leave them to the WTRU to choose and determine, the WTRU may choose and determine to use one or more PQC algorithms randomly from the designated PQC algorithms, or may choose one or more PQC algorithms based on the WTRU's context information (e.g., the WTRU's access network type, the WTRU's current location, etc.) that may also match some conditions as described in NFSSPs. It then begins interaction with the target NF instance over the established PDU session, in accordance with the received NFSSPs via Step 1117.

In the meantime, the WTRU may monitor NF-instance-specific security events based on the List of Security Monitoring Events at WTRU and generates security monitoring reports according to the WTRU Security Monitoring Report Generation and Notification IE. WTRU sends these security monitoring reports to the network, such as to SECMF.

Referring now to FIG. 12 an example method 1200 for NFSSP Creation during PDU Session Establishment is illustratively depicted. NFSSPs may be directly configured to the selected target NF instance by SECMF.

At 1201, the method 1200 may perform a similar function as Step 1101 in FIG. 11.

At 1202, the method 1200 may perform a similar function as Step 1102 in FIG. 11.

At 1203, the method 1200 may perform a similar function as Step 1103 in FIG. 11.

At 1204, the method 1200 may perform a similar function as Step 1104 in FIG. 11.

At 1205, the method 1200 may perform a similar function as Step 1105 in FIG. 11.

At 1206, the method 1200 may perform a similar function as Step 1106 in FIG. 11.

At 1207, the method 1200 may perform a similar function as Step 1107 in FIG. 11.

Note that if none of the target NF instances was discovered in Step 1205 or selected in Step 1207, Steps 1208 and 1209 may be skipped. In this case, SECMF may indicate “No Target NF Instance Found” in Step 1210. As a result, SMF may reject the WTRU's request in Step 1202 and send a rejection with the reason “No Target NF Instance Found” to the WTRU in Step 1212. Thus, Step 1213 may also be skipped.

At 1208, the method 1200 may perform a similar function as Step 1108 in FIG. 11.

At 1209, the method 1200 may perform a similar function as Step 1109 in FIG. 11. With this step, SECMF and the target NF instance may agree on the NFSSPs, which SECMF may send to and configure at the target NF instance. Within this step, if the target NF instance requests SECMF to adjust or update any NFSSPs, SECMF may send the updated NFSSPs back to the target NF instance.

At 1210, the method 1200 may perform a similar function as Step 1111 in FIG. 11. However, this response may not contain NFSSPs.

At 1211, the method 1200 may perform a similar function as Step 1112 in FIG. 11.

At 1212, the method 1200 may perform a similar function as Step 1116 in FIG. 11.

At 1213, the method 1200 may perform a similar function as Step 1117 in FIG. 11.

Referring now to FIG. 13, a method 1300 for a WTRU to establish a PDU session is illustratively depicted. The WTRU and SMF may first authenticate each other and exchange keys directly (e.g., the WTRU has received “SMF Contact Info” from the eAMF) or indirectly via the eAMF. Since the WTRU may not know the exact target NF instance it can interact with, it may indicate NF Intent (e.g., NF name or NF type) in a PDU session establishment request. After SMF receives the PDU session establishment request from the WTRU, it may discover target NF instance candidates and select appropriate target NF instance(s) for the WTRU. SMF may then pass the selected target NF instance(s) to SECMF, which may create NF-Specific Security Policies (NFSSPs) for both the WTRU and the selected target NF instance(s). SECMF may sign the created NFSSPs and send them to SMF. SMF may then configure and enforce the NFSSPs at the WTRU and the selected target NF instance(s). Finally, the WTRU may contact the selected target NF instance(s) to start E2E WTRU-NF communication according to the configured NFSSPs. The SMF in this procedure may be an evolved SMF (eSMF) supporting 6GS, which may be able to support indirect communication with the WTRU via the AMF (in 5GS) and/or direct communication with the WTRU without relaying via the AMF (in 6GS). Note that the WTRU may establish multiple PDU sessions with the same target NF instance.

In an example, the method may include NFSSP Creation during PDU Session Establishment.

At 1301, the method 1300 may perform a similar function as Step 1101 in FIG. 11.

At 1302, the method 1300 may perform a similar function as Step 1102 in FIG. 11.

At 1303, the method 1300 may perform a similar function as Step 1103 in FIG. 11.

At 1304, the method 1300 may perform a similar function as Step 1105 in FIG. 11. As a result of this step, SMF may obtain a Target NF Instance Profile for each discovered target NF instance candidate.

Note that if none of the target NF instances was discovered in Step 1304 or selected in Step 1305, Steps 1306 through 1315 may be skipped. In this case, SMF may reject the WTRU's request in Step 1302 and send a rejection with the reason “No Target NF Instance Found” to the WTRU in Step 1316. Thus, Step 1317 may also be skipped.

At 1305, the method 1300 may perform a similar function as Step 1107 in FIG. 11.

At 1306, the method 1300 may perform a similar function as Step 1104 in FIG. 11. One difference is that this step may not contain “NF Intent”, but instead may include the “Target NF Instance Profile” for each selected target NF instance, or just the identifier of the “Target NF Instance Profile”. A Target NF instance profile may comprise the identifier of a selected target NF instance and/or context information about the selected target NF instance. Step 1306 may also include QoS statistics of ongoing E2E WTRU-NF interaction that each selected target NF instance currently has with other WTRUs.

At 1307, the method 1300 may perform a similar function as Step 1106 in FIG. 11.

At 1308, the method 1300 may perform a similar function as Step 1108 in FIG. 11.

At 1309, the method 1300 may perform a similar function as Step 1109 in FIG. 11.

At 1310, the method 1300 may perform a similar function as Step 1110 in FIG. 11.

At 1311, the method 1300 may perform a similar function as Step 1111 in FIG. 11.

At 1312, the method 1300 may perform a similar function as Step 1112 in FIG. 11.

At 1313, the method 1300 may perform a similar function as Step 1113 in FIG. 11.

At 1314, the method 1300 may perform a similar function as Step 1114 in FIG. 11.

At 1315, the method 1300 may perform a similar function as Step 1115 in FIG. 11.

At 1316, the method 1300 may perform a similar function as Step 1116 in FIG. 11.

At 1317, the method 1300 may perform a similar function as Step 1117 in FIG. 11.

NFSSPs may be directly configured to the selected target NF instance by SECMF as illustrated in FIG. 14.

Referring to FIG. 14, an example method 1400 for creating NF-Specific Security Policies (NFSSPs) during a PDU session establishment may include one or more of the following steps.

At 1401, the method 1400 may perform a similar function as Step 1301 in FIG. 13.

At 1402, the method 1400 may perform a similar function as Step 1302 in FIG. 13.

At 1403, the method 1400 may perform a similar function as Step 1303 in FIG. 13.

At 1404, the method 1400 may perform a similar function as Step 1304 in FIG. 13.

At 1405, the method 1400 may perform a similar function as Step 1305 in FIG. 13.

Note that if none of the target NF instances were discovered in Step 1404 or selected in Step 1405, Steps 1406 through 1411 may be skipped. As a result, SMF may reject the WTRU's request in Step 1402 and send the rejection with a reason “No Target NF Instance Found” to the WTRU in Step 1412. Thus, Step 1413 may be skipped as well.

At 1406, the method 1400 may perform a similar function as Step 1306 in FIG. 13.

At 1407, the method 1400 may perform a similar function as Step 1307 in FIG. 13.

At 1408, the method 1400 may perform a similar function as Step 1308 in FIG. 13.

At 1409, the method 1400 may perform a similar function as Step 1109 in FIG. 11. In this step, SECMF and the target NF instance agree on the NFSSPs, which SECMF sends and configures to the target NF instance. If the target NF instance requests SECMF to adjust or update any NFSSPs, SECMF may need to send updated NFSSPs back to the target NF instance.

At 1410, the method 1400 may perform a similar function as Step 1111 in FIG. 11. This response, however, may not contain the NFSSPs.

At 1411, the method 1400 may perform a similar function as Step 1112 in FIG. 11.

At 1412, the method 1400 may perform a similar function as Step 1116 in FIG. 11.

At 1413, the method 1400 may perform a similar function as Step 1117 in FIG. 11.

FIG. 15 illustrates a procedure for WTRU to establish a PDU session. WTRU and SMF may first authenticate each other and exchange keys directly (e.g., WTRU has received “SMF Contact Info” from eAMF) or indirectly via eAMF. Since WTRU may not know the exact target NF instance it can interact with, WTRU indicates NF Intent (e.g., NF name or NF type) in a PDU session establishment request. After SMF receives the PDU session establishment from WTRU, SMF discovers target NF instance candidates and sends them to SECMF.

Then, SECMF selects appropriate target NF instance(s) for WTRU and creates NF-Specific Security Policies (NFSSPs) for both WTRU and the selected target NF instance(s). SECMF signs the created NFSSPs and sends them to SMF. Then, SMF configures and enforces NFSSPs to the WTRU and the selected target NF instance(s). Finally, WTRU contacts the selected target NF instance(s) to start E2E WTRU-NF communication according to the configured NFSSPs.

SMF in this procedure may be an evolved SMF (eSMF) supporting 6GS, which may be able to support indirect communication with WTRU via AMF (in 5GS) and/or direct communication with WTRU without relaying via AMF (in 6GS). Note that WTRU may establish multiple PDU sessions with the same target NF instance.

Referring to FIG. 15, an example method 1500 for creating NFSSPs during a PDU session establishment is illustrated. This may include NFSSP creation during PDU session establishment. The method may include one or more of the following steps.

At 1501, the method 1500 may perform a similar function as Step 1101 in FIG. 11.

At 1502, the method 1500 may perform a similar function as Step 1102 in FIG. 11.

At 1503, the method 1500 may perform a similar function as Step 1103 in FIG. 11.

At 1504, the method 1500 may perform a similar function as Step 1105 in FIG. 11. As a result of this step, SMF may obtain a Target NF Instance Profile for each discovered target NF instance candidate. Some of the discovered target NF instance candidates may have ongoing E2E WTRU-NF interaction with other WTRUs, and SMF may have obtained QoS statistics about existing PDU sessions supporting those ongoing interactions. SMF may filter out some target NF instance candidates based on those QoS statistics; for example, if the statistics indicate that an ongoing interaction between a candidate and another WTRU (in the proximity of the current requesting WTRU) does not meet the requirement, SMF may remove that candidate and not report its profile to SECMF in Step 1505. Alternatively, SMF may report all candidates and include their QoS statistics in Step 1505.

Note that if none of the target NF instances was discovered in Step 1504, Steps 1505 through 1515 may be skipped. As a result, SMF may reject the WTRU's request in Step 1502 and send a rejection with the reason “No Target NF Instance Found” to the WTRU in Step 1516. Thus, Step 1517 may be skipped as well.

At 1505, the method 1500 may perform a similar function as Step 1104 in FIG. 11. One difference is that this step may not contain “NF Intent,” but rather the “Target NF Instance Profile” for each candidate, and/or the identifier of the “Target NF Instance Profile” for each candidate. A Target NF instance profile may comprise the identifier and/or additional context information about each candidate. Note that this step may also contain QoS statistics of ongoing E2E WTRU-NF interaction that each candidate currently has with other WTRUs.

At 1506, the method 1500 may perform a similar function as Step 1106 in FIG. 11.

At 1507, the method 1500 may perform a similar function as Step 1107 in FIG. 11.

Note that if none of the target NF instances was selected in Step 1507, Steps 1508 through 1510 and Steps 1512 through 1515 may be skipped. In this case, SECMF may indicate “No Target NF Instance Found” in Step 1511. As a result, SMF may reject the WTRU's request in Step 1502 and send a rejection with the reason “No Target NF Instance Found” to the WTRU in Step 1516. Thus, Step 1517 may be skipped as well.

At 1508, the method 1500 may perform a similar function as Step 1108 in FIG. 11.

At 1509, the method 1500 may perform a similar function as Step 1109 in FIG. 11.

At 1510, the method 1500 may perform a similar function as Step 1110 in FIG. 11.

At 1511, the method 1500 may perform a similar function as Step 1111 in FIG. 11.

At 1512, the method 1500 may perform a similar function as Step 1112 in FIG. 11.

At 1513, the method 1500 may perform a similar function as Step 1113 in FIG. 11.

At 1514, the method 1500 may perform a similar function as Step 1114 in FIG. 11.

At 1515, the method 1500 may perform a similar function as Step 1115 in FIG. 11.

At 1516, the method 1500 may perform a similar function as Step 1116 in FIG. 11.

At 1517, the method 1500 may perform a similar function as Step 1117 in FIG. 11.

NFSSPs may be directly configured to the selected target NF instance by SECMF as illustrated in FIG. 16.

Referring now to FIG. 16, an example method 1600 for NFSSP creation during PDU session establishment is illustratively depicted. The method of FIG. 16 may include one or more of the following steps.

At 1601, the method 1600 may perform a similar function as step 1501 in FIG. 15.

At 1602, the method 1600 may perform a similar function as step 1502 in FIG. 15.

At 1603, the method 1600 may perform a similar function as step 1503 in FIG. 15.

At 1604, the method 1600 may perform a similar function as step 1504 in FIG. 15.

At 1605, the method 1600 may perform a similar function as step 1505 in FIG. 15. If none of the target NF instances were discovered in step 1604, steps 1605 through 1611 will be skipped. As a result, SMF may reject the WTRU's request in step 1602 and send a rejection with a reason “No Target NF Instance Found” to the WTRU in step 1612. Therefore, step 1613 will be skipped as well.

At 1606, the method 1600 may perform a similar function as step 1306 in FIG. 13.

At 1607, the method 1600 may perform a similar function as step 1307 in FIG. 13. If none of the target NF instances are selected in step 1607, steps 1608 and 1609 will be skipped. Then, SECMF may send “No Target NF Instance Found” in step 1610 to SMF. As a result, SMF may reject the WTRU's request in step 1602 and send the rejection with a reason “No Target NF Instance Found” to the WTRU in step 1612. Therefore, step 1613 will be skipped as well.

At 1608, the method 1600 may perform a similar function as step 1308 in FIG. 13.

At 1609, the method 1600 may perform a similar function as step 909 in FIG. 11. In this step, SECMF and the target NF instance may agree on the NFSSPs, which SECMF sends and configures to the target NF instance. If the target NF instance requests SECMF to update or adjust any NFSSPs, SECMF may need to return updated NFSSPs.

At 1610, the method 1600 may perform a similar function as step 1110 in FIG. 11. However, this response may not include NFSSPs.

At 1611, the method 1600 may perform a similar function as step 1112 in FIG. 11.

At 1612, the method 1600 may perform a similar function as step 1116 in FIG. 11.

At 1613, the method 1600 may perform a similar function as step 1117 in FIG. 11.

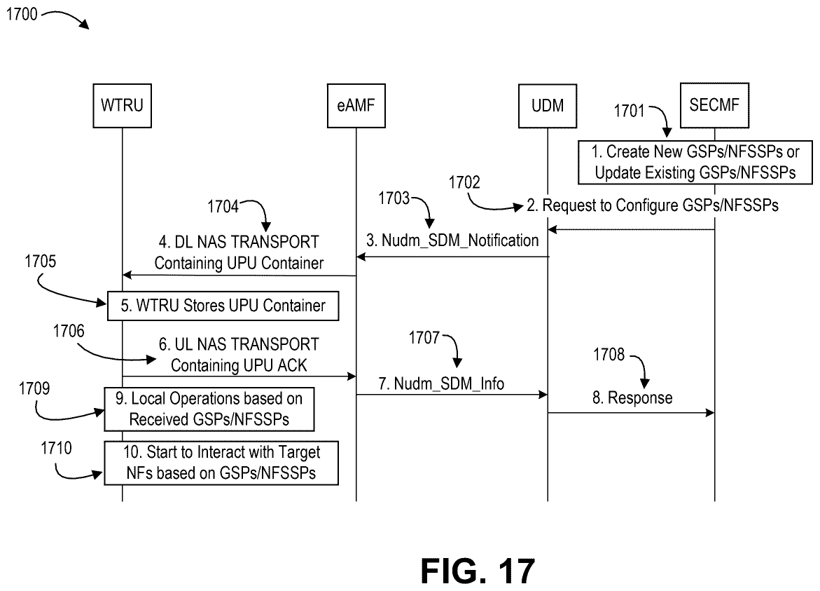

Referring now to FIG. 17, a method 1700 for pushing new GSPs and/or NFSSPs to a WTRU is illustrated. This method may include an approach in which SECMF leverages WTRU Parameter Update (UPU) procedures to deliver the new or updated GSPs/NFSSPs to the WTRU. The general security policies and/or NFSSPs may be pushed to a WTRU via a WTRU parameter update.

SECMF may actively create new GSPs or NFSSPs or update existing GSPs/NFSSPs in response to certain triggering conditions. These conditions may include, but are not limited to: eAMF informing SECMF that the WTRU has just successfully registered; SECMF receiving updated WTRU security context from other NFs such as LMF or NWDAF; changes in WTRU-related policies or PQC algorithms, with SECMF being notified by PCF; UDM informing SECMF of updated WTRU subscription data; AUSF indicating that primary authentication with WTRU is successful; an AF requesting to modify an existing PDU session; SECMF being informed that QoS statistics of an ongoing WTRU-NF PDU session fall outside of acceptable thresholds; or SECMF learning that the target NF instance has been moved (e.g., from a core to an edge cloud, or from MNO network to a public cloud).

SECMF may be subscribed to the corresponding NFs to receive automatic notifications about these triggering conditions. When triggered, SECMF creates or updates GSPs/NFSSPs and sends them to the WTRU via eAMF or other involved NFs.

The method depicted in FIG. 17 may include one or more of the following steps.

At 1701, SECMF may create new GSPs and/or NFSSPs, or update existing ones, as triggered by one or more of the above conditions.

At 1702, SECMF may send a “Request to Configure GSPs/NFSSPs” message to UDM. This message may alternatively be sent directly to eAMF without going through UDM. In that case, step 1707 would not be needed, and step 1708 would instead be performed directly between eAMF and SECMF. The message sent in step 1702 may include the WTRU ID (e.g., SUCI or SUPI), the list of GSPs and NFSSPs created or updated in step 1701, the SECMF ID, and a credential used to authenticate SECMF.

At 1703, UDM may authenticate SECMF using the SECMF ID and credential. If authorized, UDM may notify eAMF of the GSPs and NFSSPs using the Nudm_SDM_Notification service operation. This notification message may include the WTRU ID, the GSPs and NFSSPs from step 1702, the SECMF ID, and the UDM ID.

At 1704, eAMF may send a DL NAS TRANSPORT message to the WTRU. This message may include a UPU container that carries the WTRU ID and the GSPs/NFSSPs received from step 1703.

At 1705, the WTRU may receive and store the UPU container. It may extract the GSPs and NFSSPs from the container and store them locally for enforcement and future use.

At 1706, the WTRU may send a UL NAS TRANSPORT message back to the eAMF. This message may contain a UPU ACK indicating the result of processing the GSPs and NFSSPs-whether the extraction and storage were successful or failed.

At 1707, the eAMF may invoke Nudm_SDM_Info to forward the UPU ACK from step 1706 to UDM.

At 1708, UDM may send a response back to SECMF indicating whether the GSPs and/or NFSSPs were successfully delivered to the WTRU. This response may include the status information from the UPU ACK received in step 1707.

At 1709, the method 1700 may perform a similar function as step 609 in FIG. 6, and/or function that the WTRI performs between step 1116 and 1117 in FIG. 11 (e.g., the WTRU verifies NFSSPs and stores valid NFSSPs locally). In some examples, step 1709 may take place before step 1707 and/or step 1708.

At 1710, the method 1700 may perform a similar function as step 610 in FIG. 6 and step 1117 in FIG. 11.

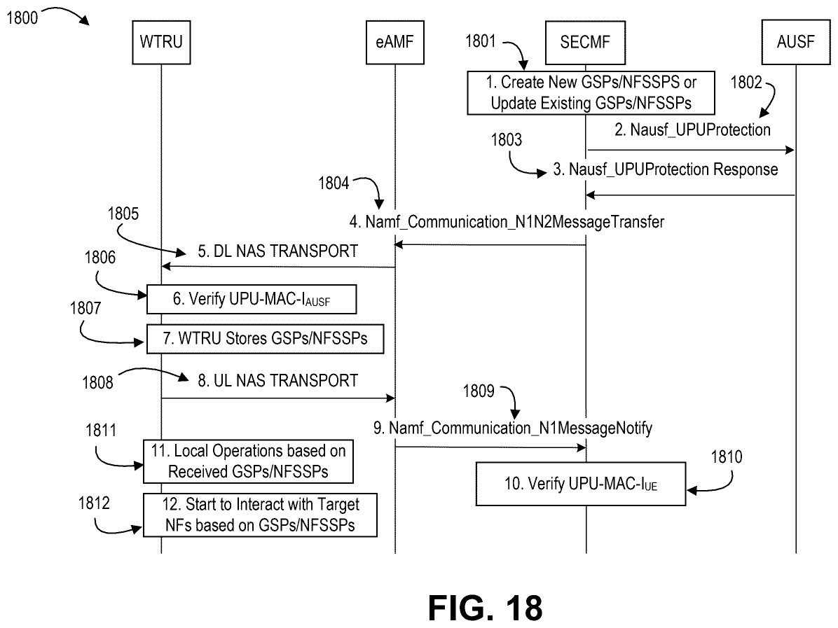

Referring now to FIG. 18, an example method 1800 for pushing GSPs/NFSSPs to a WTRU via WTRU Configuration Update with AUSF protection is illustratively depicted.

The method of FIG. 18 may include one or more of the following steps.

At 1801, the method 1800 may include SECMF creating new GSPs/NFSSPs and/or updating existing GSPs/NFSSPs as triggered by various conditions such as successful WTRU registration, reception of updated WTRU context, changes to WTRU subscription data, policy updates, and so forth.

At 1802, the method 1800 may include SECMF sending a Nausf_UPUProtection service request message to AUSF. This message may include the SECMF ID, SECMF Credential, the WTRU ID (e.g., SUCI or SUPI), and UPU Data, which indicates the GSPs/NFSSPs being created and/or updated in step 1801 and intended for configuration to the WTRU.

At 1803, the method 1800 may include AUSF authenticating and authorizing SECMF using the SECMF ID and credential. AUSF may then generate a Nausf_UPUProtection Response message and send it to SECMF. This response may include a CounterUPU, a UPU-MAC-IAUSF (calculated based on UPU Data, CounterUPU, SECMF ID, WTRU ID, and other parameters), and/or a UPU-XMAC-IUE.

At 1804, the method 1800 may include AUSF notifying eAMF of the GSPs/NFSSPs by invoking a Namf_Communication_N1N2MessageTransfer service operation. This message may include the same UPU Data as in step 1802 and the CounterUPU and UPU-MAC-IAUSF as received in step 1803.

At 1805, the method 1800 may include eAMF transparently forwarding the message from step 1804 to WTRU using a DL NAS TRANSPORT message.

At 1806, the method 1800 may include the WTRU verifying the UPU-MAC-IAUSF using KAUSF and the procedures defined for UPU protection.

At 1807, the method 1800 may include WTRU storing the UPU Data received in step 1805. The WTRU may extract and locally store any GSPs/NFSSPs contained in the UPU Data.

At 1808, the method 1800 may include WTRU sending a UL NAS TRANSPORT message containing UPU-MAC-IUE to eAMF.

At 1809, the method 1800 may include eAMF forwarding UPU-MAC-IUE to SECMF via Namf_Communication_N1MessageNotify.

At 1810, the method 1800 may include SECMF verifying UPU-MAC-IUE by comparing it to the UPU-XMAC-IUE previously received from AUSF in step 1803.

At 1811, the method 1800 may perform a similar function as step 606 in FIG. 6, and/or function that the WTRI performs between step 1116 and 1117 in FIG. 11 (e.g., the WTRU verifies NFSSPs and stores valid NFSSPs locally). IN some examples, step 1811 may take place before step 1809 and/or step 1810.

At 1812, the method 1800 may perform a similar function as step 607 in FIG. 6, and/or step 1117 in FIG. 11. In some examples, step 1812 may take place before step 1809 and/or step 1810.

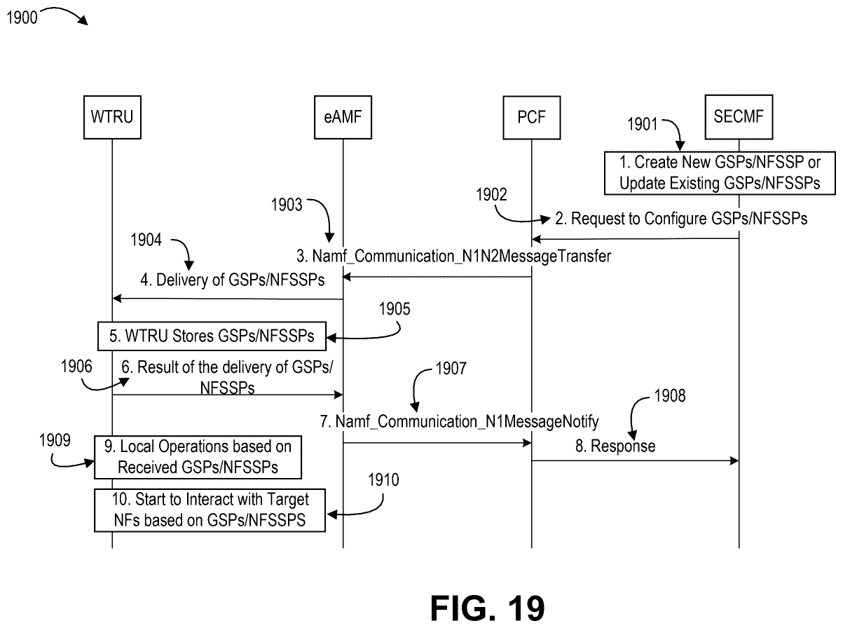

Referring now to FIG. 19, an example method 1900 for pushing GSPs/NFSSPs to a WTRU via WTRU Configuration Update is illustratively depicted.

The method of FIG. 19 may include one or more of the following steps.

At 1901, the method 1900 may include SECMF creating new GSPs/NFSSPs and/or updating existing GSPs/NFSSPs as triggered by various conditions such as successful WTRU registration, reception of updated WTRU context, changes to WTRU subscription data, policy changes, or notifications from other NFs.

At 1902, the method 1900 may include SECMF sending a request to configure GSPs/NFSSPs to PCF. This message may alternatively be sent directly to eAMF, in which case step 1907 may be skipped and step 1908 would be sent from eAMF to SECMF directly. The request may include the WTRU ID, GSPs, NFSSPs, SECMF ID, and SECMF credential.

At 1903, the method 1900 may include PCF authenticating and authorizing SECMF using its ID and credential. PCF may then notify eAMF of the GSPs/NFSSPs by invoking a Namf_Communication_N1N2MessageTransfer service operation. This message may include a WTRU Policy Container that contains the WTRU ID, the GSPs and NFSSPs received in step 1902, the SECMF ID, and optionally other WTRU policies. The message may also include the PCF ID.

At 1904, the method 1900 may include eAMF receiving the WTRU Policy Container and transparently delivering it to WTRU.

At 1905, the method 1900 may include WTRU storing the received WTRU Policy Container. The WTRU may extract and locally store any GSPs and NFSSPs from the container.

At 1906, the method 1900 may include WTRU updating its locally stored policies using the extracted GSPs and NFSSPs. WTRU may then transmit the policy update result to eAMF, such as an indication that the GSPs/NFSSPs have been successfully applied.

At 1907, the method 1900 may include eAMF forwarding the policy update result received from step 1906 to PCF using a Namf_Communication_N1MessageNotify service operation.

At 1908, the method 1900 may include PCF sending a response to SECMF indicating whether the GSPs/NFSSPs were successfully delivered and configured at the WTRU.

At 1909, the method 1900 may perform a similar function as step 606 in FIG. 6 and/or functions that the WTRU performs between step 1116 and 1117 in FIG. 11 (e.g., the WTRU may verify NFSSPs and/or store valid NFSSPs locally). In some examples, step 1909 may take place before step 1907 and/or step 1908.

At 1910, the method 1900 may perform a similar function as step 607 in FIG. 6 and/or step 1117 in FIG. 11. In some examples, step 1909 may take place before step 1907 and/or step 1908.

1. A wireless transmit/receive unit (WTRU) comprising:
a processor configured to:
send, to a network, a protocol data unit (PDU) session establishment request comprising one or more of an indication of a network function (NF) intent and one or more security requirements;
receive, from the network, NF-specific security policies (NFSSPs) in response to the PDU session establishment request, wherein the NFSSPs are associated with a target NF instance;
determine that one or more of the NFSSPs are valid NFSSPs based on a signature associated with each of the NFSSPs;
determine one or more post-quantum cryptography (PQC) algorithms based on one or more of the valid NFSSPs or WTRU context information;
perform end-to-end communication with the target NF instance based on the valid NFSSPs using one or more of the one or more PQC algorithms; and
send a security monitoring report to the network, wherein the security monitoring report is based on a WTRU security monitoring report policy for each of the valid NFSSPs.

2. The WTRU of claim 1, wherein the processor is configured to:
generate the NF intent and the one or more security requirements by determining one or more information elements that define the security requirements or the NF intent, wherein the information elements indicate one or more of a post-quantum cryptography capability of the WTRU, a description of a target network function, a desired output from the network function, or one or more quality of service (QoS) requirements.

3. The WTRU of claim 1, wherein the PDU session establishment request further comprises one or more of a WTRU context or quality of service (QoS) requirements;
wherein the NFSSPs indicate security policies for the WTRU and the target NF instance;
wherein the NF intent indicates one or more of a description of a network function or a desired output from the network function; and
wherein the WTRU context information indicates one or more of a location of the WTRU, a time, a connectivity type, or an access network type.

4. The WTRU of claim 1, wherein the NFSSPs comprise one or more post-quantum cryptography (PQC) algorithms for communication between the WTRU and the target NF instance.

5. The WTRU of claim 1, wherein the processor is configured to monitor NF-instance-specific security events based on one or more security monitoring events at the WTRU contained in the valid NFSSPs.

6. The WTRU of claim 1, wherein the processor is configured to:
generate a WTRU security context comprising a post-quantum cryptography capability of the WTRU; and
send a registration request message to the network, wherein the registration request message comprises the WTRU security context.

7. The WTRU of claim 6, wherein the processor is configured to receive a registration accept message comprising one or more of a general security policy (GSP) identifier, a uniform resource identifier (URI), or a uniform resource locator (URL) of one or more GSPs.

8. The WTRU of claim 7, wherein the processor is configured to receive, from the network, the one or more general security policies (GSPs) based on one or more of the GSP identifier, the URI, or the URL, and to store the one or more GSPs received from the network.

9. The WTRU of claim 8, wherein the one or more general security policies (GSPs) comprise a list of NF types that the WTRU is allowed to communicate with directly and parameters used to establish the PDU session, wherein the parameters comprise one or more of a data network name (DNN), a single network slice selection assistance information (S-NSSAI), or an identifier of an evolved session management function (eSMF).

10. The WTRU of claim 8, wherein the processor is configured to verify the one or more general security policies (GSPs), enforce the one or more GSPs, monitor security-related events according to the one or more GSPs, generate one or more security monitoring reports, and send the security monitoring reports to the network.

11. A method performed by a wireless transmit/receive unit (WTRU), the method comprising:
sending, to a network, a protocol data unit (PDU) session establishment request comprising one or more of an indication of a network function (NF) intent and one or more security requirements;
receiving, from the network, NF-specific security policies (NFSSPs) in response to the PDU session establishment request, wherein the NFSSPs are associated with a target NF instance;
determining that one or more of the NFSSPs are valid NFSSPs based on a signature associated with each of the NFSSPs;
determining one or more post-quantum cryptography (PQC) algorithms based on one or more of the valid NFSSPs or WTRU context information;
performing end-to-end communication with the target NF instance based on the valid NFSSPs using one or more of the one or more PQC algorithms; and
sending a security monitoring report to the network, wherein the security monitoring report is based on a WTRU security monitoring report policy for each of the valid NFSSPs.

12. The method of claim 11, further comprising:
generating the NF intent and the one or more security requirements by determining one or more information elements that define the security requirements or the NF intent, wherein the information elements indicate one or more of a post-quantum cryptography capability of the WTRU, a description of a target network function, a desired output from the network function, or one or more quality of service (QoS) requirements.

13. The method of claim 11, wherein the PDU session establishment request further comprises one or more of a WTRU context or quality of service (QoS) requirements;
wherein the NFSSPs indicate security policies for the WTRU and the target NF instance;
wherein the NF intent indicates one or more of a description of a network function or a desired output from the network function; and
wherein the WTRU context information indicates one or more of a location of the WTRU, a time, a connectivity type, or an access network type.

14. The method of claim 11, wherein the NFSSPs comprise one or more post-quantum cryptography (PQC) algorithms for communication between the WTRU and the target NF instance.

15. The method of claim 11, further comprising monitoring NF-instance-specific security events based on one or more security monitoring events at the WTRU contained in the NFSSPs.

16. The method of claim 11, further comprising:
generating a WTRU security context comprising a post-quantum cryptography capability of the WTRU; and
sending a registration request message to the network, wherein the registration request message comprises the WTRU security context.

17. The method of claim 16, further comprising receiving a registration accept message comprising one or more of a general security policy (GSP) identifier, a uniform resource identifier (URI), or a uniform resource locator (URL) of one or more GSPs.

18. The method of claim 17, further comprising receiving, from the network, the one or more general security policies (GSPs) based on one or more of the GSP identifier, the URI, or the URL, and storing the one or more GSPs.

19. The method of claim 18, wherein the one or more general security policies (GSPs) comprise a list of NF types that the WTRU is allowed to communicate with directly and parameters used to establish the PDU session, wherein the parameters comprise one or more of a data network name (DNN), a single network slice selection assistance information (S-NSSAI), or an identifier of an evolved session management function (eSMF).

20. The method of claim 18, further comprising verifying one or more general security policies (GSPs), enforcing the one or more GSPs, monitoring security-related events according to the one or more GSPs, generating one or more security monitoring reports, and sending the security monitoring reports to the network.
